(19) United States
(12) Patent Application Publication
(10) Pub. No.: US 2009/0158163 A1
(43) Pub. Date: Jun. 18, 2009

(54) System and method to facilitate social browsing

(75) Inventors: Ryan J. Stephens, Naples, FL (US); Peter Weinberg, Fort Myers, FL (US)

Correspondence Address: TIMOTHY P. O'HAGAN, 8710 KILKENNY CT, FORT MYERS, FL, 33912, US

(73) Assignee: Slingpage, Inc., Fort Myers, FL (US)

(21) Appl. No.: 12/002,441

(22) Filed: Dec. 17, 2007

(51) Int. Cl. G06F 15/16; G06F 3/048

(52) U.S. Cl. 715/738; 709/217

(57) ABSTRACT

A social browsing system for operation with a source client system operated by a first user and a target client system operated by a second user—wherein each of the source client system and the target client system comprise a browser executing thereon. The social browsing system may comprise a social browsing infrastructure system and a local component for installation on each of the source client system and the target client system. The local component may comprise source functions and target functions. The source functions may be adapted to: i) render a redirect control in association with an instance of the browser; ii) in response to user activation of the redirect control, obtain a location URL from the web browser; and iii) generate a redirect invite to the social browsing infrastructure system. The social browsing infrastructure system may be adapted to, in response to receiving the redirect invite: i) identify the target client system operated by the second user; ii) generate an inbound redirect invite to the target client system; and iii) identify an advertisement placement. The advertisement placement may be related to at least one of: i) web content at the location URL; and ii) behavioral data related to the second user. The infrastructure system may be further adapted to provide the advertisement placement to the target client system. The target functions may be adapted to, in response to receipt of the inbound redirect invite; i) initiate a connection to the location URL for rendering of the web content; and ii) render the advertisement placement in association with the web content.

### TECHNICAL FIELD

The present invention relates to a system and method for facilitating social browsing amongst at least two individuals, each of which operates a distinct browser.

### BACKGROUND OF THE INVENTION

Web browser systems and their operation are well known. In general, a web browser accepts input of a universal resource locator (URL) and, in response thereto, interfaces with local lower level IP service and networking systems to: i) initiate a domain name server (DNS) inquiry to a domain name server to obtain an IP address associated with input URL; and ii) initiate a TCP/IP connection with a web server at such IP address. In response, the web server provides a web document object for rendering by the browser.

The most common means for input of a URL to a browser include: i) user typing of a URL into a text box control of a browser; and ii) user selecting a hyperlink within a web document object that associates with a URL.

Further, many text based programs (for example word processors, email clients, and chat/instant message clients) include a function which automatically reformats text that is in a URL format to a hyperlink. As such, the formatted text becomes a control which, if selected by the user (for example the user clicking on the text), drives the program generates a process start call to the operating system which spawns a browser and directs such browser to the URL associated with the hyperlink.

Utilizing existing technology is extremely cumbersome for a first user of a browser operating on a first system (e.g. a first browser) to direct a second user operating a browser on a second system which is independent from the first system (e.g. a second browser).

For example, the first user could telephone the second user and annunciate the URL and the second user would type the URL into the second browser.

As another example, the first user could cut and past the URL from the first browser to an email client for sending to the second user. Upon receipt the second user's email client is likely to format the URL as a hyperlink and, if clicked by the second user, initiate a start process call to the operating system to spawn a browser and direct the browser to the URL.

As yet another example, the first user could cut and past the URL from the first browser to a chat or instant message client with an open session with the second user. Upon receipt by the second user's chat or instant message client the URL is likely to be reformatted as a hyperlink and, if clicked by the second user, initiate a start process call to the operating system to spawn a browser and direct the browser to the URL.

As yet another example, the first user may select a “send link” command in the first browser. In response thereto, the first browser may initiate a start process call to the operating system to spawn a new email object and insert the URL into a body portion of the new email object. The first user then may address the email object and activate a send command for purposes of sending the email to the second user. Again, upon receipt the second user's email client is likely to format the URL as a hyperlink and, if clicked by the second user, initiate a start process call to the operating system to spawn a browser and direct the second browser to the URL.

Each of these processes is cumbersome and becomes even more cumbersome if the two users are trying to coordinate their browsing such that they are looking at multiple web pages in a common sequence and communicating about the web pages.

As such, what is needed is a system and method to facilitate social browsing amongst two individuals, each of which operates a distinct browser. More specifically, what is needed is a system and method that provides a convenient means for: i) initiating a social browsing session amongst the two individuals; ii) enabling each individual to direct the other individual's browser to a specified URL; and iii) facilitating convenient communication between the individuals.

### SUMMARY OF THE INVENTION

A first aspect of the present invention comprises a social browsing system for operation with a source client system operated by a first user and each of one or more target client systems operated by a second user, or group of users. Each of the source client system and the target client system include a web browser executing thereon.

The social browsing system comprises a social browsing infrastructure system and a local component for installation on each of the source client system and each target client system.

The local component may comprise a browser plug-in and a listener module. The plug-in may be adapted to load with each instance of the web browser and may be adapted to, upon loading, establish a tool bar communication connection to the listener module. The plug-in may further include source plug-in functions and target plug-in functions.

The listener module may comprise an internet protocol client module adapted to maintain a communication connection with at least one system of the social browsing infrastructure system and an internet protocol server module adapted to maintain, with each plug-in, the tool bar communication connection therewith. The listener module may further include source listener functions and target listener functions.

The source plug-in functions include rendering of a sling, or redirect, control within a tool bar of the instance of the browser and/or in association with the browser. Upon activation of the redirect control, the source plug-in functions may be adapted to generate a properties request to the instance of the local browser and receive identification of the location URL from the instance of the local browser in response to the properties request.

The location URL is the URL of the web page being rendered by the instance of the browser at the time of the properties request. The source plug-in functions further include: i) obtaining an identification associated with the second user, or group of users (e.g. invitee user ID or invitee group ID); and ii) generating an outbound redirect invite method call (e.g. a sling) to the listener module utilizing the tool bar communication connection therewith. The outbound redirect invite method call includes at least identification of the location URL and the identification associated with the second user or group of users.

The source listener functions include an outbound redirect invite method responsive to the outbound redirect invite method call initiated by the plug-in. The outbound redirect invite method is adapted to generate a redirect invite method call to the remote social browsing infrastructure system, or more specifically to a lobby service system of the infrastructure system. The redirect invite method call includes at least the identification of the location URL and the identification associated with the second user or group of users.

The target listener functions include an inbound redirect invite method responsive to an inbound redirect invite method call initiated by the social browsing infrastructure system. The inbound redirect invite method call includes at least identification of the location URL. The inbound redirect invite method may be adapted to one of: i) launch a new instance of the browser and direct such new instance of the browser to the location URL; and ii) generate an overload page method call to one of the plug-ins over the toolbar connection therewith. The overload page method call may include at least the location URL.

The target plug-in functions include an overload page method responsive to receipt of the overload page method call initiated by listener. The overload page method is adapted to direct the instance of the browser to load a web document obtained from a web server associated with the location URL within an existing browser window by making an applicable call (such as navigate to URL) to an application interface of the browser that is available to plug-ins.

The lobby service system of the social browsing infrastructure systems may include a redirect invite method responsive to receipt of the redirect method call. The redirect invite method may be adapted to generate the inbound redirect invite method call to the listener module associated with the second user or each of the group of users (e.g. the invitee(s)) identified in the redirect invite method call.

In one sub embodiment, the source plug-in function of obtaining an identification associated with the second user, or group of users, may include rendering a buddy list control in association with the browser. The buddy list control may displaying a list of at least two potential identifications (e.g. user IDs of other users or group IDs of groups of other users). In this sub embodiment, obtaining the identification associated with the second user, or group of users, may be by way of obtaining first user identification of a selected one of the at least two identifications from the buddy list control. The buddy list control may be rendered after user activation of the redirect control. Alternatively, the redirect control may be embodied within the buddy list control (for example a buddy list control rendered along a side of the browser window) such that a single activation of a control within the buddy list control operates to both initiate the redirect and select the second user.

In another sub embodiment, the inbound redirect invite method is further adapted to: i) in response to receipt of the inbound redirect invite method call, render an acceptance control; and ii) generate the overload page method call only in response to user activation of the acceptance control.

Further, the inbound redirect invite method may be further adapted to only generate the overload page method call to an instance of the browser that is associated with an initiator ID matching identification of an initiator included in the inbound redirect invite method call.

In this sub embodiment, if the identification of an initiator included in the inbound redirect invite method call does not match an initiator ID associated with an existing instance of the browser, the inbound redirect invite method call may be adapted to: i) generate a processing call to launch a new instance of the browser upon user activation of the acceptance control; and ii) associate the new instance of the browser with the identification of the initiator included in the inbound redirect invite method call in the connections table.

In an embodiment of the present invention supporting chat communication, the source listener functions may be further adapted to: i) generate a get room ID method call to the social browsing infrastructure system, or more particularly to a chat service system of the social browsing infrastructure system; ii) receive, in response thereto, identification of a chat room; and iii) generate a chat invite method call to the social browsing infrastructure system, or more particularly to the lobby service system, for delivery of chat resource information (chat service ID and the identification of the chat room) to each target client system.

In this embodiment, the plug-in is further adapted to: i) render a chatbar graphical user interface in association with the browser; ii) establish a chatbar connection to the listener for supporting a chat session; and iii) upon user entry of text into the chatbar, generate a relay text method call to the listener utilizing the chatbar connection.

The source listener functions are further adapted to, in response to the relay text method call, generate a relay text method call to the remote social browsing infrastructure system, or more particularly to the chat service system—for purposes of relaying the text to the listener module of each target client system.

The target listener functions are further adapted to receive, from the lobby service system of the remote infrastructure system, an inbound chat invite method call which includes chat resource information (chat service ID and the identification of the chat room). In response thereto, the target listener module functions are adapted to: i) associate the chat resource information with an instance of the browser; and ii) generate an open chat method call to the plug-in of the instance of the browser. The open chat method call may identify the chat resource information. The plug-in may, in response to the open chat method call: i) render the chatbar graphical user interface in association with the browser; and ii) open the chatbar connection to the listener for supporting the chat session.

In another sub embodiment, the listener module may further comprise a get advertisement function. The get advertisement function may be adapted to: i) generate an ad request for transfer to an advertisement system; and ii) receive, in response to the ad request, an advertisement placement for rendering in association with an instance of the browser. In exemplary embodiments, the ad request may include at least one of: i) identification of the location URL associated with the instance of the browser, and ii) identification of a portion of content of the web page being rendered by the instance of the browser.

A second aspect of the present invention comprises a local system for operation with at least one instance of a web browser on a source client system operated by a first user; with a remote social browsing infrastructure system; and at least one target client system operated by a second user, or group of users, for purposes of redirecting a browser operating on each target client system to a location URL.

The local system may include a listener module comprising: i) an internet protocol client module adapted to maintain a communication connection with the remote social browsing infrastructure system; and ii) an internet protocol server module adapted to maintain, with each of a plurality of instances of a browser plug-in, a tool bar communication connection therewith.

Each instance of the browser plug may operate in conjunction with an instance of the browser and be adapted to: i) establish the toolbar communication connection to the listener module; and ii) render a sling, or redirect, control in association with the instance of the browser.

The plug-in may be further adapted to: i) upon user activation of the redirect control, generate a properties request to the instance of the browser to a location URL, the location URL being a URL of a web page being rendered by the instance of the browser at the time of the properties request; ii) receive identification of the location URL from the instance of the local browser in response to the properties request; iii) obtain an identification associated with the second user or group of users; and iv) generate an outbound redirect invite method call to the listener module utilizing the toolbar communication connection therewith. The outbound redirect invite method call may include identification of the location URL and the identification associated with the second user or group of users.

The listener module may further comprise an outbound redirect invite method responsive to the outbound redirect invite method call. The method may be adapted to generate a redirect invite method call to the remote social browsing infrastructure system over the communication connection therewith. The redirect invite method call may include at least the identification of the location URL and the identification associated with the second user or group of users.

To support user selection of the remote system, the plug-in may be further adapted to: i) render a buddy list control in association with the browser, the buddy list control displaying a list of at least two identifications; and ii) obtain the identification associated with the second user, or group of users, by first user identification of one of the at least two identifications.

The listener module may further comprise an inbound redirect invite method callable by the remote social browsing infrastructure system or, more specifically, callable by a lobby service system of the remote social browsing infrastructure system.

The inbound redirect invite method may be adapted to: i) if an instance of the browser is associated with an initiator identified in the inbound redirect invite method call, generate an overload page method call to the plug-in of the instance of the browser associated with the initiator; and ii) if the initiator identified in the inbound redirect invite method call is not associated with an existing instance of the browser: i) generate a processing call to launch a new instance of the browser; and ii) associate the new instance of the browser with the initiator identified in the inbound redirect invite method call.

The overload page method call may comprise at least a URL received in the inbound redirect invite method call from the remote social browsing infrastructure system. The plug-in further comprises an overload page method responsive to receipt of the overload page method call from the listener module. The overload page method may be adapted to direct the instance of the browser to load a web document obtained from a web server associated with the URL into an existing browser window:

In one sub embodiment, the listener module may be further adapted to, in response to receipt of the inbound redirect invite method call, render an acceptance control. In this sub embodiment, the listener may generate the overload page method call to the plug-in and generate the processing call to launch a new instance of the browser, in each case, only in response to user activation of the acceptance control.

In an embodiment supporting chat, the listener module may be further adapted to: i) generate a get room ID method call to the social browsing infrastructure system and receive, in response thereto, identification of a chat room; and ii) generate a chat invite method call to the social browsing infrastructure system.

The plug-in may be further adapted to: i) render a chatbar graphical user interface in association with the browser; and ii) upon user entry of text into the chatbar, generating a send text method call to the listener module.

The listener module may further yet be adapted to, in response to the send text method call, generate a relay text method call to the remote social browsing infrastructure system. The relay text method call may include both the text and the chat room ID.

Similarly, the listener may be further adapted to, in response to receipt of an inbound chat invite method call from the remote infrastructure system: i) associate chat resource information (inclusive of a chat service ID and a chat room ID identified in the inbound chat invite method call) with an instance of the browser; and ii) generate an open chat method call to the plug-in of the instance of the browser. The open chat method call may also include the chat resource information.

The plug-in may be adapted to render the chatbar graphical user interface in association with the browser and establish a chatbar connection to the listener in response to receipt of the open chat method call.

Again, in this second aspect, the listener may further comprise a get advertisement function. Again, the get advertising function may be adapted to: i) generate an ad request for transfer to an advertisement system; and ii) receive, in response to the ad request, an advertisement placement for rendering in association with the local browser. Again, the advertisement request may include at least one of: i) identification of the location URL, and ii) identification of a portion of content of the web page being rendered by the local browser.

A third aspect of the present invention comprises a plug-in to a local browser operated by a first user for redirecting a remote browser operating on one or more target client systems operated by a second user, or group of users, to a location URL. The plug-in comprises a tool bar graphical user interface adapted to render a sling, or redirect, control in association with an instance of the browser. The plug-in further comprises an invite function adapted to: i) in response to user activation of the redirect control, generate a properties request to the browser to obtain a location URL, the location URL being a URL of a web page being rendered by the browser at the time of the properties request; ii) receive identification of the location URL in response to the properties request; iii) obtain an identification associated with the second user or group of users; and iv) initiate transfer of the location URL to the target client system.

To facilitate obtaining the identification associated with the second user, or group of users, the tool bar graphical user interface may be further adapted to: i) render a buddy list control displaying a list of at least two identifications; and ii) obtain the identification associated with the second user, or group of users, by first user identification of a selected one of the at least two identifications.

The plug-in may further include an overload page method adapted to, in response to a receipt of an overload page method call identifying a remote URL, initiate a processing call to an application interface of the browser to direct the browser to connect to the remote URL and obtain a web document for loading into an existing browser window.

For purposes of supporting chat, the plug-in may further comprise a chat invite function adapted to, in response to user activation of one of the redirect control and a chat control of the tool bar graphical user interface: i) initiate establishing a chat session with each target client system; ii) render a chatbar graphical user interface in association with the local browser; and iii) upon user entry of text into the chatbar graphical user interface, initiate relay of the text to the selected remote system.

A fourth aspect of the present invention comprises a social browsing system for operation with a source client system operated by a first user and at least one target client system operated by a second user, or group of users—wherein each of the source client system and the target client system comprising a web browser executing thereon. The social browsing system may comprise a social browsing infrastructure system and a local component for installation on each of the source client system and the target client system. The local component may comprise source functions and target functions.

The source functions may be adapted to: i) render a redirect control in association with an instance of the web browser; ii) in response to user activation of the redirect control, obtain a location URL from the web browser; and iii) generate a redirect invite to the social browsing infrastructure system. The redirect invite may comprise at least identification of the location URL and an identification of the second user or group of users. The location URL may be a URL of web content being rendered by the instance of the browser.

The social browsing infrastructure system may be adapted to, in response to receiving the redirect invite: i) identify each target client system operated by the second user or group of users; ii) generate an inbound redirect invite to the target client system; and iii) identify an advertisement placement. The advertisement placement may be related to at least one of: i) web content at the location URL; and ii) behavioral data related to the second user. The infrastructure system may be further adapted to provide the advertisement placement to the target client system.

The target functions may be adapted to, in response to receipt of the inbound redirect invite; i) initiate a connection to the location URL for rendering of the web content; and ii) render the advertisement placement in association with the web content.

The source functions may be further adapted to: i) render a buddy list control in association with the browser, the buddy list control displaying a list of at least two identifications; and ii) obtaining the identification associated with the second user, or group of users, by first user identification of a selected one of the at least two identifications.

The target functions may further yet be adapted to, in response to receipt of the inbound redirect invite, render an acceptance control and, in response to user activation of the acceptance control: i) initiate a connection to the location URL for rendering of the web content by way of spawning of a new instance of the browser; or ii) directing an existing instance of the browser to the location URL.

As such, the local component may include a browser plug-in and directing an existing instance of the browser to the location URL may comprise providing an overload page method call to the plug-in of the existing instance of the browser. The plug-in may be adapted to overload existing web content by initiating a navigate to location processing call to the browser. The navigate to location processing call includes the location URL.

The source functions may further yet be adapted to: i) render a chatbar graphical user interface in association with at least one instance of the browser; and ii) generate a chat invite to the social browsing infrastructure system. The chat invite may include identification of the second user.

The social browsing infrastructure system may be further adapted to, in response to receipt of the chat invite, generate in inbound chat invite to each target client system.

The target functions may be further adapted to, in response to receipt of the inbound chat invite, render a chatbar graphical user interface in association with an instance of the browser in which web content obtained from the location URL is rendered. Each chatbar, upon user entry of text into the chatbar, may generate a relay text method call to the social browsing infrastructure system for subsequent relay to the other chatbar.

For a better understanding of the present invention, together with other and further aspects thereof, reference is made to the following description, taken in conjunction with the accompanying drawings. The scope of the present invention is set forth in the appended claims.

### BRIEF DESCRIPTION OF THE DRAWINGS

FIG. 1 is a block diagram representing exemplary architecture for implementing a network based system and method for facilitating social browsing in accordance with an embodiment of the present invention;

FIG. 2a is a ladder diagram representing an exemplary process for redirecting a remote browser to selected web content in accordance with an embodiment of the present invention;

FIG. 2b is a ladder diagram representing an exemplary process for establishing a chat session between two client systems in accordance with an embodiment of the present invention;

FIG. 3 is a diagram representing exemplary operation of certain processes related to user authentication and provisions of a user's buddy list;

FIG. 4 is a diagram depicting an exemplary user interface useful for facilitating social browsing in accordance with an embodiment of the present invention;

FIG. 5 is a diagram depicting an exemplary user interface useful for facilitating social browsing in accordance with an embodiment of the present invention;

FIG. 6 is a diagram depicting an exemplary user interface useful for facilitating social browsing in accordance with an embodiment of the present invention;

FIG. 7 is a diagram depicting an exemplary user interface useful for facilitating social browsing in accordance with an embodiment of the present invention;

FIG. 8 is a diagram depicting an exemplary user interface useful for facilitating social browsing in accordance with an embodiment of the present invention;

FIG. 9 is a block diagram depicting exemplary structure of a client system in accordance with an exemplary embodiment of the present invention;

FIG. 10 is a block diagram depicting exemplary processes included in a plug-in component of a client system in accordance with an exemplary embodiment of the present invention;

FIG. 11a is a block diagram depicting exemplary processes included in a listener component of a client system in accordance with an exemplary embodiment of the present invention;

FIG. 11b is a block diagram depicting exemplary processes included in a listener component of a client system in accordance with an exemplary embodiment of the present invention;

FIG. 12 depicts an exemplary connections table in accordance with an exemplary embodiment of the present invention;

FIG. 13 depicts exemplary steps for selecting an advertisement placement for rendering in conjunction with an instance of the web browser in accordance with an exemplary embodiment of the present invention;

FIG. 14 depicts exemplary steps for providing recent sling data, hot sling data, or related sling data in conjunction with an instance of the web browser in accordance with an exemplary embodiment of the present invention; and

FIG. 15 depicts exemplary web documents rendering recent sling data, hot sling data, or related sling data in conjunction with an instance of the web browser in accordance with an exemplary embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

It should also be appreciated that table structures represented in this application are exemplary only and intended to show the mapping of relationships between various data elements. Other table structures may store similar data elements in a manner that maintains the relationships useful for the practice of the present invention.

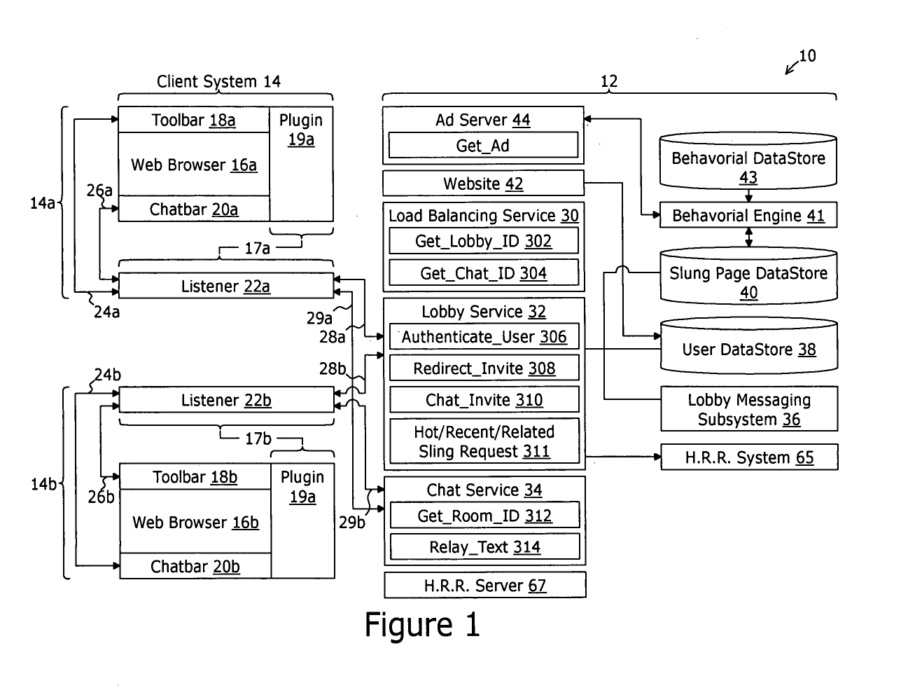

FIG. 1 represents an overview of exemplary architecture for implementing a network based system and method for facilitating social browsing in accordance with an embodiment of the present invention (the social browsing system 10).

The system 10 comprises an infrastructure system 12 and a local component 17a, 17b for installation on each of a plurality of client systems 14a, 14b respectively. Each local component 17a, 17b may comprise a listener 22a, 22b as well as a browser plug-in component 19a, 19b. In the exemplary embodiment, the listener 22a, 22b may be a widget application which is loaded into memory for execution at start up of the client system 14a, 14b. The browser plug-in 19a, 19b may be a data link library file which drives operation of each instance of the web browser 16a, 16b in accordance therewith.

The browser plug-in (for example browser plug-in 19a) may comprise a toolbar graphical user interface 18a (referred to as the tool bar) and a chatbar graphical user interface 20a (referred to as the chatbar).

Although the toolbar 18 and the chatbar 20 are represented as, and may be implemented as, a single browser plug-in component 19 it should be appreciated that the tool bar 18 and the chatbar 20 may be implemented as separate browser plug-ins.

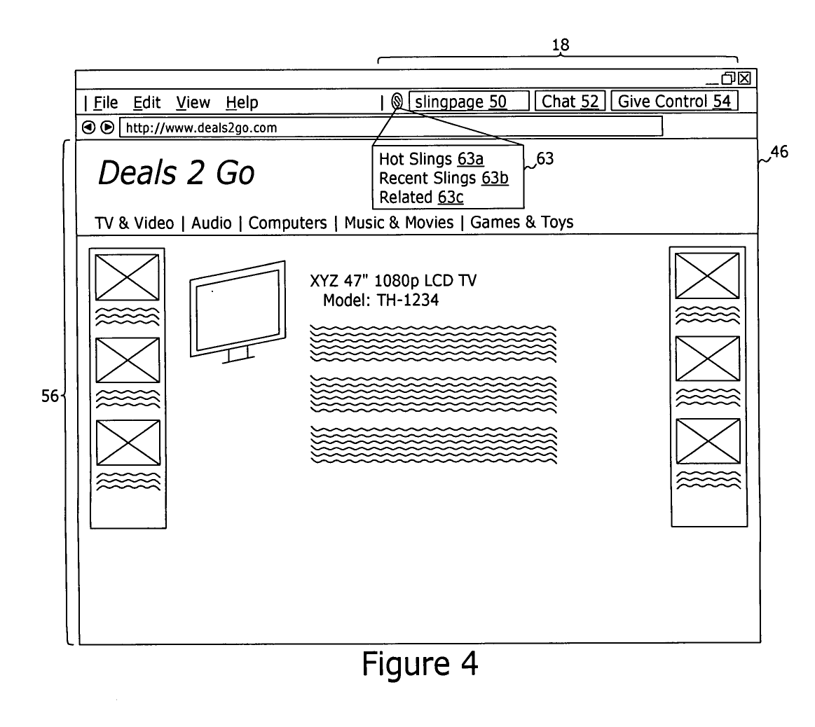

Turning briefly to FIG. 4 in conjunction with FIG. 1, the toolbar 18 may be rendered within, or associated with, a browser window 46 of each instance of the web browser 16 operating on the client system 14. In an exemplary embodiment, the toolbar 18 may comprise a redirect (e.g. sling page) control 50, a chat control 52, and an auto accept control 54—which may also be referred to as a “give control” control 54.

Further, the toolbar 19 may include a combination of a hot sling control 63a, a recent sling control 63b, and a related sling control 63c which may be implemented as a drop down menu 63 or other known control technology. Functions related to each of these controls is discussed herein.

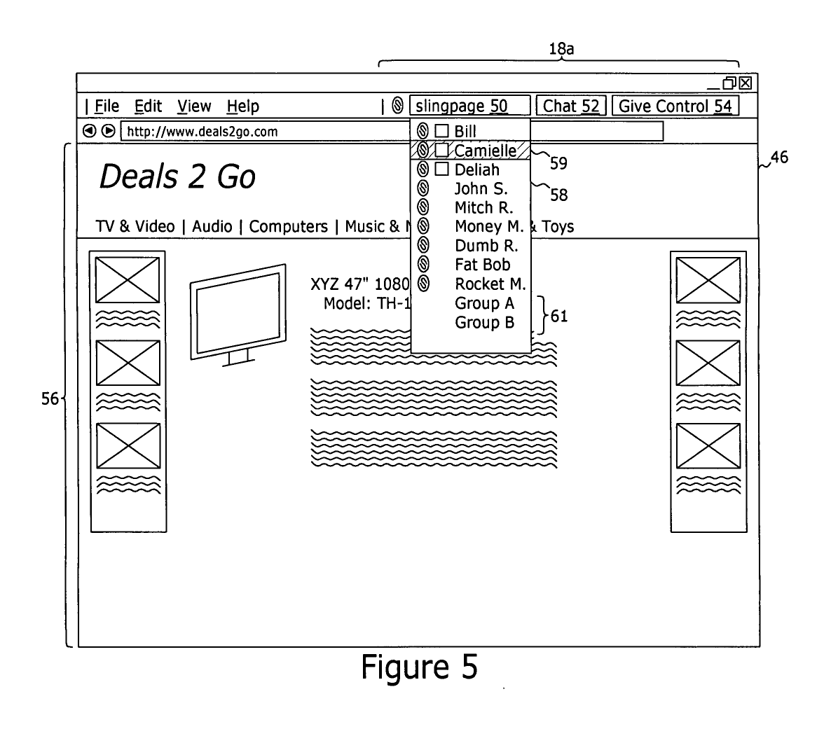

Further, with brief reference to FIG. 5, the tool bar may include a buddy list control 58. The buddy list control 58 depicted in FIG. 5 may be rendered upon user activation of either the redirect control 50 or the chat control 52. The buddy list control 58 lists user ID's of potential invitees (or groups of invitees 61) to which the user may desire to sling a web page, chat, or otherwise participate in a social browsing session. The buddy list control 58 may further identify, for each user, whether the user is currently logged into the system (connected to the infrastructure system 12 of FIG. 1). The buddy list control 58 may include a highlight bar 59 controllable by a mouse or pointer to solicit and obtain user selection of a selected invitee or group. For purposes of the description, each reference to an invitee is intended to also encompass a group of invitees.

As an alternative to the “pop up” buddy list control 58 depicted in FIG. 5, it is envisioned that a buddy list control may be rendered within a frame of the browser window or otherwise associated with the browser—such as along the left side of the browser window.

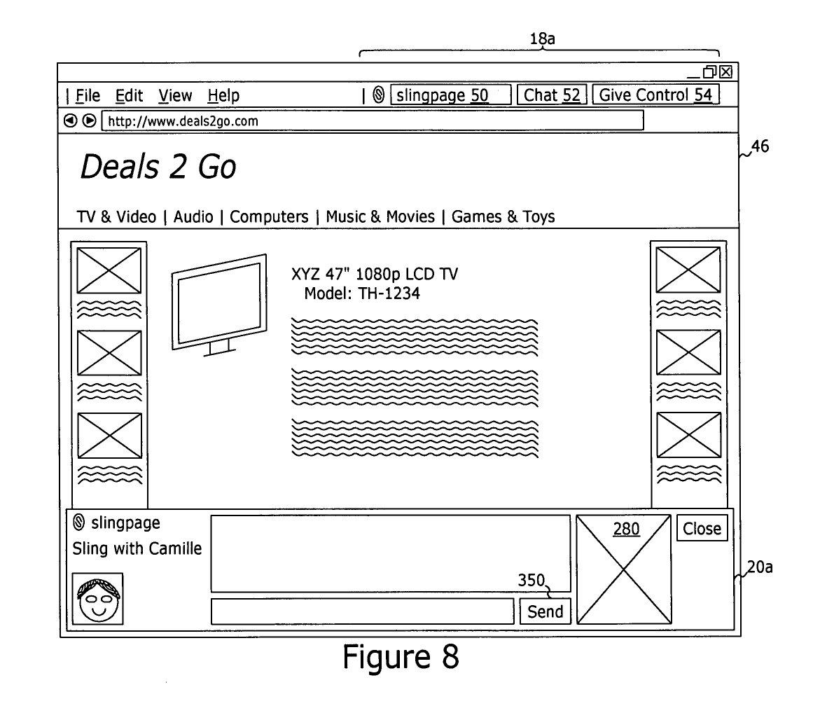

Turning briefly to FIG. 8, in conjunction with FIG. 1, the chatbar 20 may be rendered within, or associated with, a browser window 46 of each instance of the web browser operating on the client system 14. In the exemplary embodiment, the chatbar 20 may be rendered only in response to certain events which commence a chat session and, when rendered, may include a text window 250, a text entry control 256 (inclusive of a send control 350), a close window control 258, and at least one advertisement placement 280.

Returning to FIG. 1, the infrastructure system 12 generally includes a load balancing service 30, one or more lobby service systems 32, and one or more chat service systems 34 as the primary components with which clients 14a, 14b interface for purposes of sharing internet web pages, chatting, and otherwise participating in a social browsing session.

Each of the load balancing service system 30, lobby service system 32, and chat service system 34 may operate as a web server making certain callable methods available to each of the client systems 14a,14b utilizing known technologies such as web services/simple object access protocols (SOAP) messaging and/or messaging over TCP/IP connections.

More specifically, the load balancing service 30 may make each of a Get_Lobby_ID method 302 and a Get_Chat_ID 304 method available to client systems 14. Each lobby service system 32 may make each of a Authenticate_User method 306, a Redirect_invite method 308, and a Chat_Invite method 310 available to client systems. Each chat service system 32 may make each of a Get_Room_ID method 312 and a Relay_Text method 314 available to client systems.

In operation, the combination of the local component 17a, 17b installed on each of multiple client systems 14a, 14b and the described methods made available by components of the infrastructure system 12 provide a system for sharing internet web pages, chatting, and otherwise participating in a social browsing session.

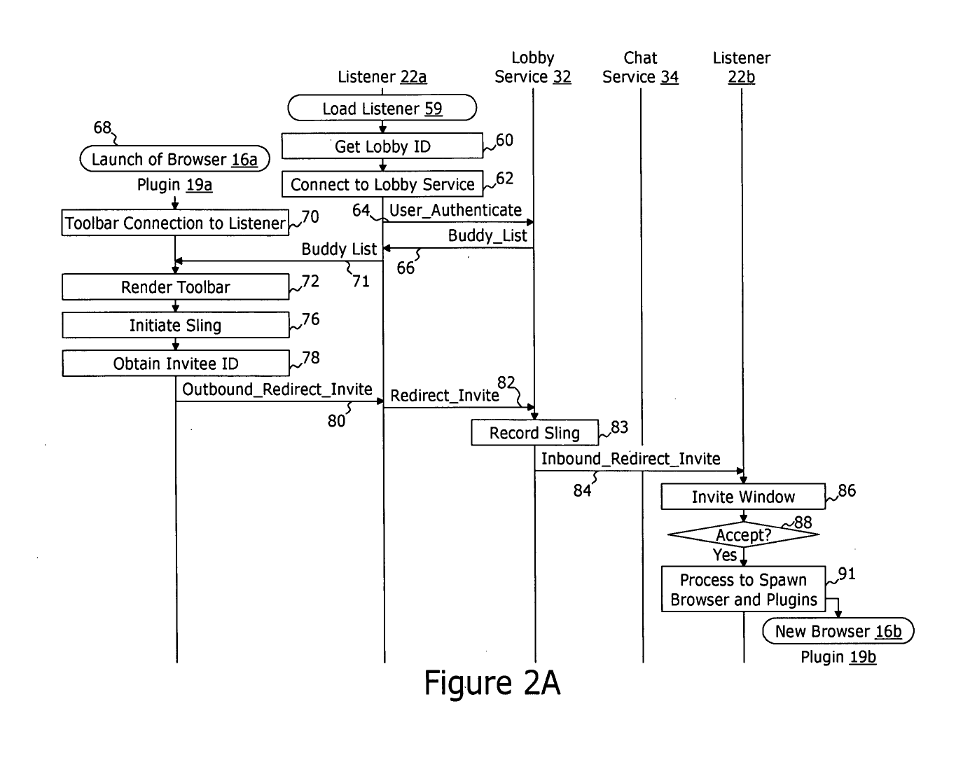

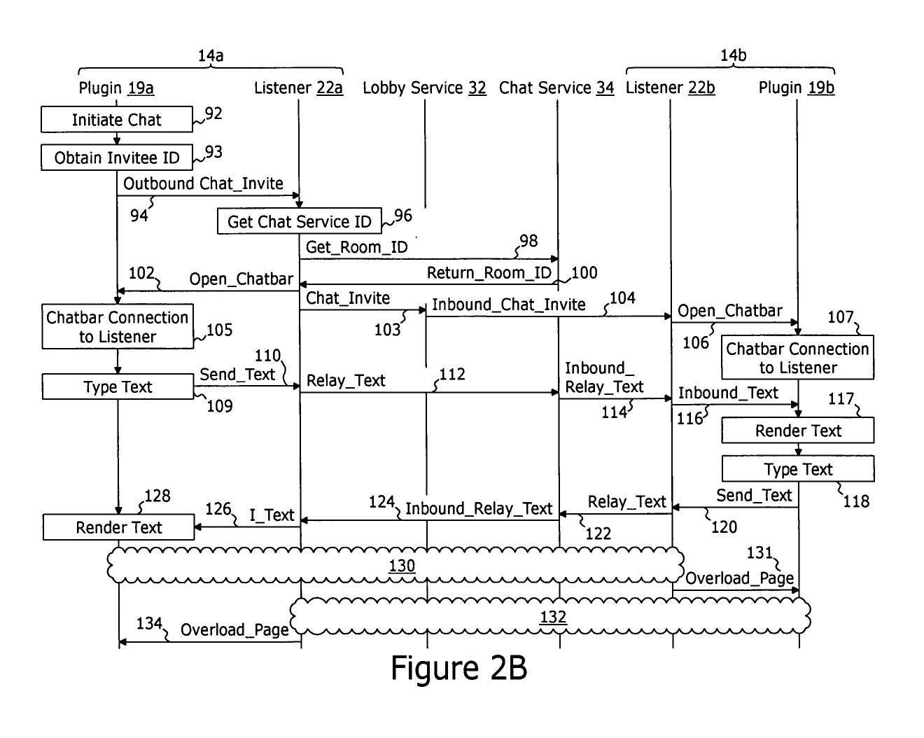

In more detail, referring to FIG. 2a in conjunction with FIG. 1, upon loading of the listener (for example loading of listener 22a on system 14a) as represented by step 59, the listener 22a may obtain a lobby ID identifying a lobby service system 32 to which the listener 22a is to connect. Obtaining the lobby ID is represented by step 60.

Because the infrastructure system 12 may comprise multiple lobby service systems 32, each of which supports a group of client systems 14, the Get_Lobby_ID method 302 made available by the load balancing server 30 may be called by a client system, for example client system 14a, for purposes of obtaining a lobby service ID (e.g. a unique identification (such as IP address) of a lobby service system 32 to which the client system 14a is to connect).

In response to a Get_Lobby_ID method call, the load balancing service 30 will generate a Return_Lobby_ID method call back to a Return_Lobby_ID method of the listener 22a. The Return_Lobby_ID method call may include the lobby ID.

After the listener 22a obtains a lobby ID identifying a lobby service system 32, the listener 22a may establish a persistent TCP/IP connection 28a with the identified lobby service system 32 as represented by step 62.

Upon establishing the TCP/IP connection 28a the listener 22a, may generate an Authenticate User method call to the Authenticate_User method 306 (step 64) for purposes of identifying the user of the client system 14a to the lobby service system 32.

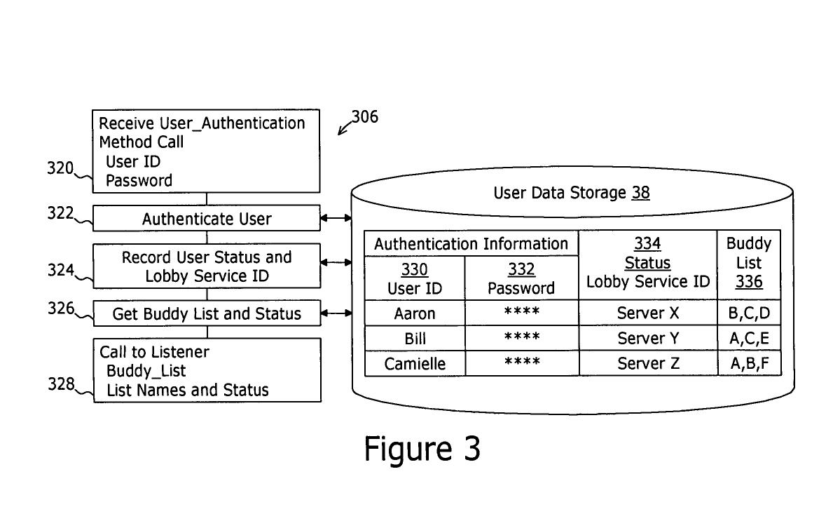

Turning to FIG. 3 in conjunction with FIG. 1, the Authenticate User method call may include a User ID uniquely identifying the user of the client system 14a and the user's password—as represented by box 320.

The Authenticate_User method 306 may be adapted to, in response to receipt of the Authenticate_User method call, authenticate the user by comparison of the authentication information provided in the method call (e.g. provided user ID and password) to authentication information comprising a user ID 330 and password 332 stored in a user data storage 38.

The lobby service system 32 may further update (represented by box 324) the registered users status 334 in the user data storage 38 to reflect that the user is logged-in. Further, user data storage 38 may identify the lobby service system 32 to which the registered user is connected if the implementation utilizes a centralized database for associating each logged in user with a supporting lobby service system. However, other methods be used for associating a logged in user with a particular lobby service system 32 that do not require recording of such data in a central data storage. Examples include distributed system, and algorithmic systems.

The lobby service system 32 may further yet obtain a buddy list 336 associated with the registered user at step 326. In more detail, each registered user, for example registered user “Aaron” or “A” may be associated with one or more other registered users as part of Aaron's buddy list 336. In this example, Aaron's buddy list comprises at least registered users “B”, “C” and “D”. The user data storage 38 may also store the status of each registered user in the form of identifying whether the registered user is “off-line” or “on-line”.

The lobby service system 32 may, at step 328 generate a Buddy List method call (represented by box 328) back to a Buddy_List method made available by the listener 22a for purposes of providing the registered user's buddy list and the status of each buddy to the listener 22a. Returning to FIG. 2a in conjunction with FIG. 1, step 66 represents return of the buddy list to the listener 22a.

Upon launch of an instance of the web browser 16 (represented by step 68) the plug-in 19a may establish a toolbar TCP/IP connection 24a to the listener 22a as represented by step 70. Step 71 represents the listener 22a, in response to the connection 24a being established, providing the buddy list to the plug-in 19a for purposes of populating the buddy list control 58 of the tool bar 18a as depicted in FIG. 5. Step 72 represents rendering of the tool bar 18 in association with the newly spawned browser window 46.

For purposes of clarity, reference to an instance of the browser 16 or an instance of the browser window 46 is intended to also include an instance of a distinct tab in a browser implementation that includes tabs. Additionally, reference to an instance of the browser 16 or an instance of the browser window 46 may include any unique aspect of a browser application or a browser window distinguished from a separate aspect or window by a unique browser ID number.

Turning to FIG. 5 in conjunction with FIG. 2a, a first registered user, for example Aaron (the initiator), may, while browsing Internet web page content 56 within the browser window 46, activate the sling page or redirect control 50 (represented by step 76) for purposes of sharing the web page content 56 with a second registered user, for example Camielle (the invitee) of a different client system, for example client system 14b (the invitee system).

The plug-in 19a may further render the buddy list control 58 of the tool bar 18 for purposes of obtaining user identification of the invitee. More specifically, the buddy list control 58: i) lists other registered users, and groups, (potential invitees) which are associated with the initiator; ii) distinguishes between such potential invitees which are currently “on line” and those that are “off line”; and iii) enables user selection of an invitee from the potential invitees utilizing, for example, a pointer controlled highlight bar 59. Obtaining user selection of an invitee is represented by step 78.

Although FIG. 5 depicts the buddy list control 58 being rendered in response to user activation of the redirect control 50, other means for user initiating a redirect and selection of an invitee form a buddy list may include rendering of the buddy list along the side of the browser window and include a redirect control in association with each on-line buddy. Selection of such a control operates as both activation of the redirect control and selection of the invitee.

Following user selection of an invitee, the plug-in 19a may generate an Outbound Redirect Invite method call to the listener 22a over the toolbar TCP/IP connection 24a as represented by step 80. The Outbound Redirect Invite method call may include at least the location URL at which the web browser 16a is currently located (e.g. the URL where the web content 95 currently rendered was obtained).

In response thereto, the listener 22a may initiate a Redirect Invite method call (Step 82) a to the Redirect_Invite method 308 made available by the lobby service 32 to which the listener 22a has established the TCP/IP connection 28a for purposes of directing the lobby service system 32 to relay the URL of the web content 56 rendered within the initiator's browser window 46 to the invitee's client system 14b—such that an instance of the browser 16 on the invitee's client system 14b may be redirected to such URL for purposes of rendering such web content 56 to the invitee.

As will be discussed in more detail herein, the Redirect Invite method call may comprise at least: i) identification of the initiator by user ID (e.g. Aaron); ii) identification of the invitee by user ID (e.g. Camielle); and iii) the location URL (e.g. the URL of the web content 56 rendered within the initiator's browser window 46).

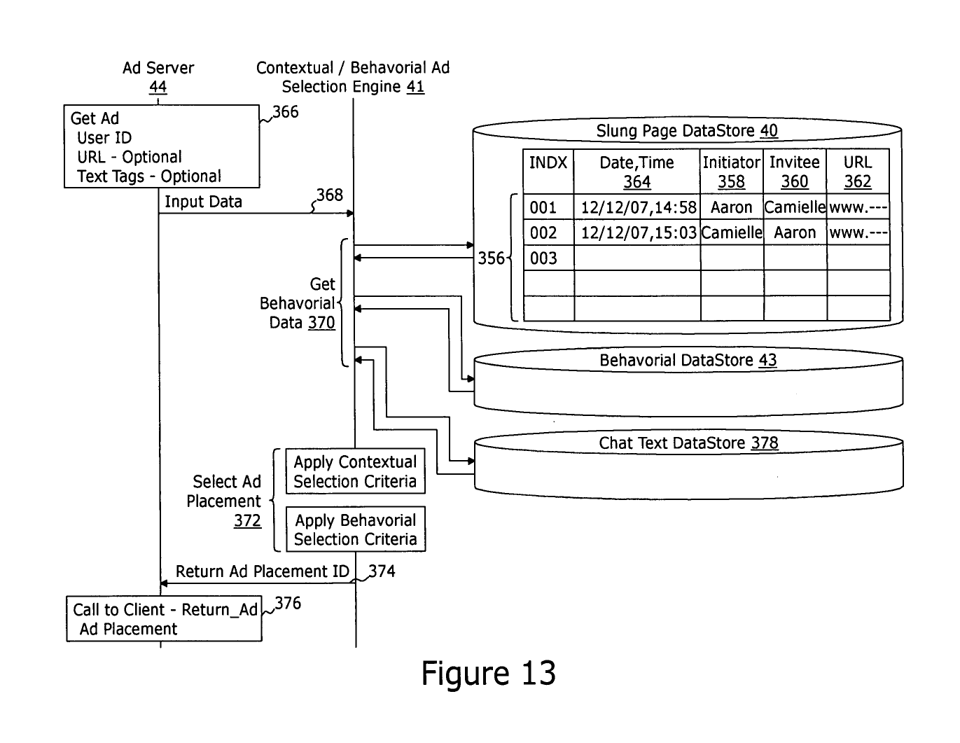

In response to receipt of the Redirect Invite method call, the lobby service 32 executes its Redirect_Invite method 308 which is adapted to record the redirect in the slungpage data storage 40 as depicted by step 83. Turning briefly to FIG. 13, recording the redirect in the slung page data storage may 40 may include writing a record 356 which associates identification of the initiator 358 (e.g. Aaron), identification of the invitee 360 (e.g. Camielle), identification of the location URL 362, and a date and time 364 at which the method call is processed by the lobby service system. As will be discussed in more detail, recording of slung page activity may be used for purposes of selecting relevant advertisement placements for rendering to either the initiator or the invitee.

Returning again to FIG. 2a in conjunction with FIG. 1, the Redirect_Invite method 308 is further adapted to: i) locate the invitee client system(s) 14b associated with the invitee or group of invitees (e.g. the TCP/IP connection 28b with the client system(s) 14b from which the invitee logged into the lobby server system 32); and ii) initiate an Inbound Redirect Invite method call to each invitee's client system 14b over the persistent TCP/IP connection 28b. The Inbound Redirect Invite method call is represented by step 84. As will be discussed in more detail herein, the Inbound_Redirect_Invite method call comprises at least: i) identification of the initiator by user ID (e.g. Aaron); ii) identification of the invitee by user ID or group ID (e.g. Camielle); and iii) the location URL. Further, it is envisioned that the location URL may be provided in association with appended data identifying the infrastructure system 12, or an operator of the infrastructure system 12 such that a web server providing web content at the URL may associated the connection request from the target client system with the infrastructure system 12 or the operator of the infrastructure system 12.

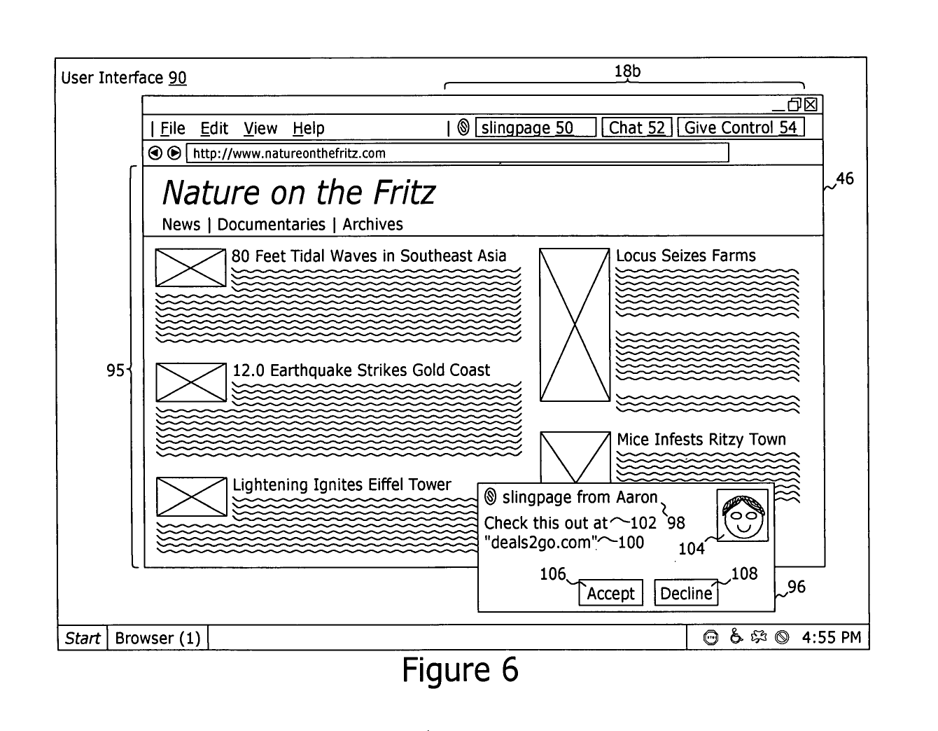

Turning briefly to FIG. 6, a graphical user interface 90 of the invitee's client system 14b is depicted. The graphical user interface 90 may include typical interface controls inclusive of system tray icons 92. The system tray icons 92 may include a Slingpage icon 94. The graphical user interface 90, in a traditional manner, may also include open windows for active applications as represented by browser window 46 depicting web content 95. With reference to FIG. 6 in conjunction with FIG. 2a, upon receipt of the Inbound Redirect Invite method call, the listener 22b of the client system 14b may render an invite notification window which may be implemented as a system tray slider window 96. Rendering the invite window 96 is represented by step 86.

Depicted in the invite notification window 96 may be an initiator identification 98 identifying the initiator by user ID (e.g. Aaron), a URL identification 100 identifying the location URL and/or web content that the initiator desires to share; a message text 102 (which may be input by the initiator and passed as part of the Redirect Invite method call and the Inbound Redirect Invite method call); and other information such as a thumbnail photograph 104 of the initiator. The invite notification window 96 may further include an acceptance control 106 and a decline control 108. The decline control 108 may simply close the invite notification window.

Returning to FIG. 2a, in response to the invitee activating the acceptance control (depicted by decision box 88), the listener 22b calls a function of the operating system (such as process.start in the Microsoft Windows environment) to spawn a new browser 16b and direct such new browser 16b to the location URL (represented by step 91) for purposes of rendering the same web content 56 as rendered in the initiators browser window 46 (FIG. 5) at the time of initial activation of the slingpage control 50.

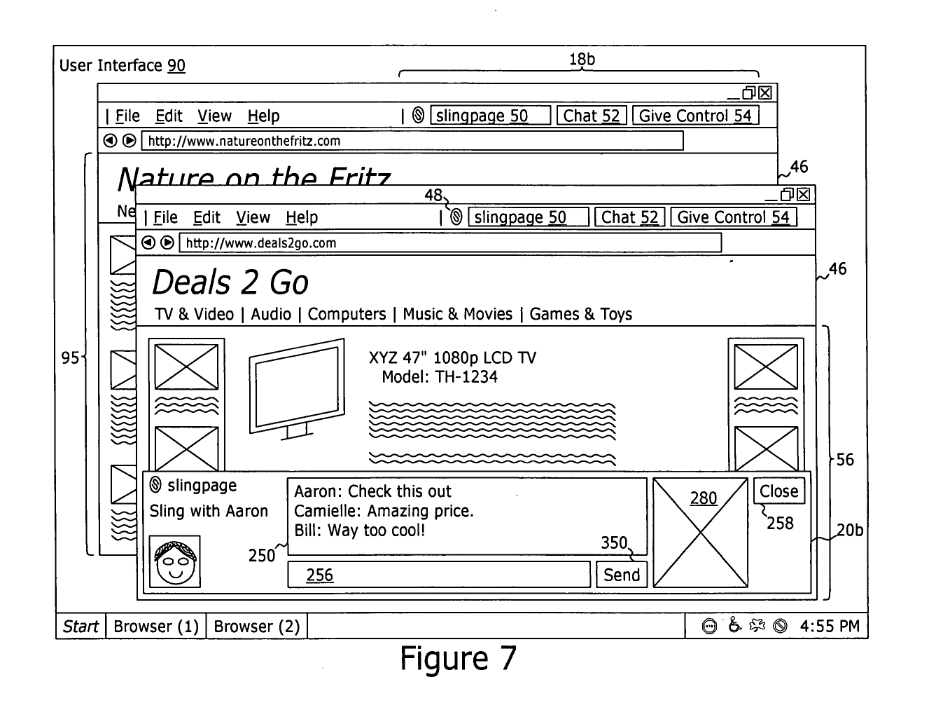

Following the spawning of the new browser 16b within the invitee's user interface 90, as depicted in FIG. 7, each of the initiator and the invitee are viewing the same web content 56.

Returning briefly to FIG. 1 in conjunction with FIG. 3, it should be appreciated that although only a single lobby service 32 is depicted in FIG. 1, a typical implementation will include multiple lobby service systems 32. It is envisioned that the initiator client system 14a and the invitee client system 14b may have TCP/IP connections 28a, 28b established with different lobby service systems 32.

To enable listener 22a to initiate the Redirect Invite method call to the particular lobby service system 32 with which it is connected (e.g. server X) and have a different lobby service system 32 which listener 22b is connected (e.g. server Y) initiate the Inbound Redirect Invite method call, a lobby messaging sub system 36 (which may be a combination of persistent TCP/IP connections between the various servers) may enable passing of method calls between the multiple lobby service systems 32.

In one aspect, the user data storage 38 may identify the particular lobby service system with which the user is connected within the status field 334 (for example Aaron is supported by server X while Camielle is supported by Server Y. As such, each lobby service may access the user data storage 38 for identifying the lobby service supporting the invitee. In other aspects, such information may be distributed to all lobby service system or, if each registered user is assigned to a lobby service system using a particular hash algorithm, each lobby service system may independently operate such hash algorithm to identify the lobby service supporting the invitee.

In addition to the steps discussed with respect to FIG. 2a for purposes of rendering common web content 56 within browser window 46 of each of the initiator client system 14a and the invitee client system 14b. It is envisioned that establishing a corresponding chat session between the browser windows 46 depicting the common web content 56 facilitates a social browsing experience. The chat session may be set up in conjunction with the exemplary steps for slinging a web page from client system 14a to client system 14b (e.g. the exemplary steps discussed with respect to FIG. 2a) or, with reference to FIG. 5 in conjunction with FIG. 2b, the chat session may be set up following the user activating the chat control 52 independent of activation of the redirect control 50.

In more detail, and referring to the diagram of FIG. 2b, in response to activation of the redirect control 50 and/or in response to independent activation of the chat control 52 (represented by step 92), the plug-in 19a may display the buddy list control 58 for purposes of identification of an invitee (or again, a group). In the event that the user has activated the redirect control 50, user identification of an invitee may be for purposes of both purposes of the redirect process discussed with respect to FIG. 2a and for purposes of setting up the chat session. In either event, obtaining user selection of an invitee is represented by step 93.

Following user selection of an invitee, the plug-in 19a may initiate an Outbound Chat Invite method call to the listener 22a (represented by step 94) utilizing the toolbar connection to the listener 22a (e.g. connection 24a as depicted in FIG. 1). The Outbound Chat Invite method call may comprise at least identification of the invitee.

In response to receipt of the Outbound_Chat_Invite method call, the listener 22a obtains a chat service ID identifying a chat service system to 34 to which the listener 22a may connect for purposes of supporting the chat session. In more detail, and with reference to FIG. 1 in conjunction with FIG. 2b, because the infrastructure systems 12 may comprise multiple chat service systems 32, each of which supports multiple chat sessions between client systems 14, the Get_Chat_ID method 304 may be called by a client system, for example client system 14a, for purposes of obtaining identification of a chat service system 34 to which the client system 14a is to connect for purposes of a chat session with another client. In response to a Get_Chat_ID method call, the load balancing service 30 will generate a Return_Chat_ID method call back to a Return_Chat_ID method on the client system 14a. The Return_Chat_ID method call may include a chat room ID identifying (for example by unique IP address) of a chat service system 34 to which the client 14a is to connect. Obtaining the chat service ID is represented by step 96.

After obtaining the chat service ID, the listener 22a may establish a TCP/IP connection 29a to the identified chat service 34 and through such TCP/IP connection 29a, initiate a Get_Room_ID method call (represented by step 98) to the Get_Room_ID method 312 made available by the chat service 34.

The chat service 34 may initiate a Return Room ID method call to a Return_Room_ID method made available by listener 22a for purposes of providing a unique Room ID such that each client participating in the chat session may, by inclusion of the unique Room ID in Relay_Text method calls, effect relay of text to the other client(s) participating in the chat session. Return of the unique Room ID is represented by step 100.

Upon receipt of the unique room ID, the listener 22a may generate an Open Chatbar method call to the plug-in 19a as represented by step 102. The Open Chatbar method call may include the chat resource information inclusive of the chat service ID identifying the chat service system 34 and the unique Room ID.

In response to receipt of the Open Chatbar method call, the browser plug-in may: i) direct rendering (e.g. pop up) of the chatbar 20 within, or associated with, the initiators browser window 46 as depicted in FIG. 8; and establish the chatbar connection 26a (FIG. 1) to the listener 22a for support of the chat session. Such processes are represented by step 105.

Referring again to FIG. 1 in conjunction with FIG. 2b, also in response to receipt of the unique room ID, the listener 22a may generate a Chat Invite method call to the Chat_Invite method 310 made available by the lobby service 32 over the TCP/IP connection 28a for purposes of passing identification of the chat service system 34 and a chat room ID to each invitee's client system 14b. The chat invite method call is represented by step 103. As will be discussed in more detail herein, the Chat Invite method call comprises at least: i) identification of the invitee or group; ii) the chat service ID; and the chat room ID. Identification of the initiator may also be included in the Chat Invite method call.

In response to receipt of the Chat Invite method call the lobby service 32 may initiate an Inbound Chat Invite method call to the listener 22b of each invitee client system 14b over the TCP/IP connection 28b therewith. The Inbound Chat Invite method call is represented by step 104. As will be discussed in more detail herein, the Inbound Chat Invite method call may comprise the same information as the Chat Invite method call.

Upon receipt of the Inbound Redirect Invite method call the listener 22b: i) opens a TCP/IP connection 29b with the chat service 34 identified in the Inbound Redirect Invite method call 64; and ii) generates an Open Chatbar method call to the plug-in 19b. Similar to operation of the plug-in 19a, the plug-in 19b may: i) directs rendering (e.g. pop up) of the chatbar 20b within, or associated with, the invitee's browser window 46 as depicted in FIG. 7; and establish the chatbar connection 26b (FIG. 1) to the listener 22b for support of the chat session. Such processes are represented by step 107.

It should be appreciated that although the exemplary embodiment provides for rendering of each chatbar 20 within the browser window 46, rendering of a chatbar independent of the browser window is also envisioned.

Following the opening of each chatbar 20, text typed by each user is exchanged between the participating client systems 14a, 14b by initiating Relay Text method calls to the Relay_Text method 314 (FIG. 1) of the chat service system 34.

More specifically, referring to FIG. 8 in conjunction with FIG. 1 and FIG. 2b, upon user activation of a send control 350 of the chatbar 20a, the chatbar 20a initiates a Send Text method call to its listener 22a over the chatbar TCP/IP connection 26 as represented by step 110. The Send Text method call comprises at least the chat service ID, the unique room ID, and the text to be relayed.

In response to receipt of the Send Text method call, listener 22a initiates a Relay Text method call the Relay_Text method 314 made available by the chat services system 34 over the TCP/IP connection 29a established therewith. The Relay Text method call is represented by step 112. The Relay Text method call comprises at least the unique Room ID and the text to be relayed.

In response to the Relay Text method call, chat services 34 generates an Inbound Text method call to each listener 22b of clients participating in the chat room over TCP/IP connection 29b as represented by step 114. In turn, the listener 22b generates an Inbound Text method call to the plug-in 29b over the chatbar TCP/IP connection 26b as represented by step 116. The plug-in then renders the text received in the Inbound Text method call within the chatbar 20b as represented by step 117.

Similarly, text typed into chatbar 20b (as represented by step 118) may be sent for rendering in chatbar 20a following a similar process of the plug-in 19b generating a Send Text method call to the listener 22b (step 120), the listener 22b generating a Relay Text method call to the chat service 34 (step 122), the chat service 34 generating an Inbound Relay Text method call to each listener 22a (step 124), the listener 22a generating an Inbound Text method call to the plug-in 19a (step 126), and the plug-in 19a rendering the text as represented by step 128.

Further yet, additional web content may be exchanged between the users for the duration of a social browsing session. More specifically, an initiator (again using toolbar client system 14a as the exemplary initiating client system) may initiate sending of Internet web site additional content to the invitee (again using client system 14b as the exemplary invitee client system). Upon user activation of the redirect control 50, the Outbound_Redirect_Invite method call to the listener 22a, the Redirect_Invite 62 to the lobby service 32, and the Inbound_Redirect_Invite 64 to the listener 22b of the invitee will be generated as discussed above (represented by cloud box 130). However, to further provide the experience of a social browsing session, it is envisioned that in the event the initiator activates the redirect control 50 in a browser window 46 which includes (or is associated with) an activate chatbar 20, the default invitee may be the registered user with which the chat session is open.

Similarly, the listener 22b, after receiving an Inbound_Redirect_Invite method call may not utilize a processing call to the operating system to spawn a new browser if an existing browser window 46 includes (or is associated with) a chat session with the initiator identified in the Inbound_Redirect_Invite method call. Instead, the listener 22b may instead initiate an Overload_Page method call to the plug-in 19b of such existing browser window 46 over the tool bar TCP/IP connection 24. The Overload_Page method call 120 comprises at least the location URL provided in the Inbound Redirect Invite method call.

In response to receiving the Overload_Page method call, the plug-in 19b may initiate a call to a navigate to URL method of the web browser's plug-in API for purposes of redirecting the browser to the location URL.

Further, in the event that the invitee has activated the auto accept control 54 of the browser window 46, the listener 22b may initiate the Overload Page method call to the plug-in 19b directly in response to receipt of the Inbound Redirect Invite method call 64 without intervening processes of generating an invite window 96 and obtaining user activation of an accept control 106 (both depicted in FIG. 6).

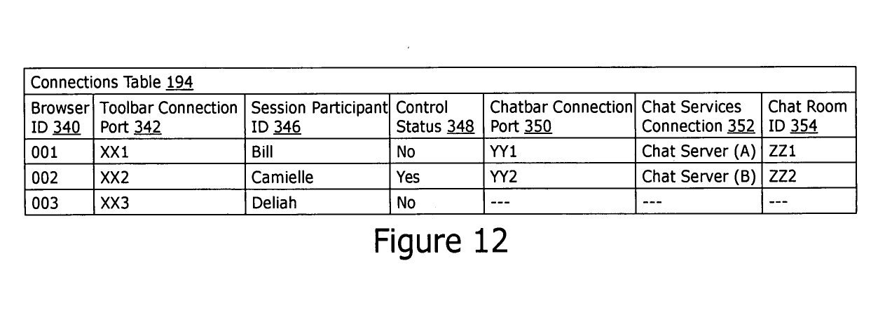

More specifically, referring briefly to FIG. 12, a connections table 194 (maintained by each listener 22) may associate each active instance of the browser (by browser ID 340) with: i) a tool bar connection port ID 342 identifying the toolbar connection 24; ii) a session participant ID 346 identifying the other registered user to which, or from which, pages have been slung in accordance with the steps of FIG. 2a and/or a chat session has been established in accordance with the steps of FIG. 2b; iii) a control status identifier 348 indicting whether the user has granted control of the browser to such session participant; iv) a chatbar connection port ID 350 identifying the chatbar connection 26 (if any); v) a chat services ID 354 identifying the chat services system 34 (if any) supporting the chat session (if any); and a chat room ID 354 identifying the unique chat room assigned for supporting the chat session (if any).

When an Inbound Redirect Invite method call is received, if the initiator identified in the method call is the session participant 346 associated with an existing instance of the browser—as identified in the connections table 194, the listener 22b may initiate the Overload Page method call to the plug-in 19b of such existing instance of the browser.

Further, in the event that the control status 348 indicates that the user has given control to the initiator identified in the method call, such Overload Page method call may be initiated without requiring that the user activate an acceptance control 106 (FIG. 6).

Returning to FIG. 2b, the user of client system 14b may initiate sending of additional Internet web site content to the user of client system 14a. Upon user activation of the redirect control 50, an Outbound Redirect Invite method call to the listener 22b, a Redirect Invite method call to the lobby service 32, and an Inbound Redirect Invite method call to the listener 22a will be generated. Such processes are represented by cloud box 132.

Again, assuming that the client system 14a includes an existing browser window 46 that includes (or is associated with) a chat session with the client system 14b, the client system 14a may initiate an Overload_Page method call (step 134) to the plug-in 19a of such existing browser window 46 over the tool bar TCP/IP connection instead of opening a new browser window utilizing the process.start call.

Again, in the event that the control status 348 of the connections table 194 indicates that the user has activated the auto accept control 54 of the browser window 46, the listener 22a may initiate the Overload_Page method call (step 134) directly in response to receipt of the Inbound_Redirect_Invite method call without intervening processes of generating an invite window.

Further yet, referring again to FIG. 7 in conjunction with FIG. 1, for purposes of monetizing social browsing, periodically during the duration of the social browsing session, each listener 22 may initiate a Get Ad method call to the ad server 44 of the social browsing infrastructure systems 12.

Turning briefly to FIG. 13 in conjunction with FIG. 1, the Get Ad method call may includes at least the user ID of the registered user of the system 14. Further, the Get Ad method call may optionally include identification of a recently slung location URL and/or identification of a portion of a web page being rendered by an instance of the browser, for example text tags extracted from the web page. Step 366 represents receipt of the Get Ad method call.

In response to the Get Ad method call, the ad server 44 may input such data elements to a contextual/behavioral selection engine 41 as represented by step 368. The selection engine 41 may reference the slung page data store 40 for purposes of identifying one or more web pages (by URL) that have been slung to the user, or slung by the user, within a recent time period. As discussed, the lobby service system 32 may initiate writing of a record 356 to the slung page data store 40 each time a Redirect Invite method call is received.

Further, the selection engine 41 may: i) reference a behavioral data storage 43 for obtaining information related to both the initiator and the invitee; and ii) reference a chat text data store 378 for obtaining chat text of the initiator and the invitee (or their associated buddies) related to recently slung pages (as identified in the slung page data store 40). Referencing the slung page data store 40, the behavioral data store 43, and the chat text data store 378 are resented by step 70.

Further yet, the selection engine 41 may apply contextual selection criteria and/or behavioral selection criteria—utilizing any combination of data obtained from the slung page data store 40, the behavioral data store 43, and the chat text data store 378 to identify a relevant advertisement as represented by step 372 and, as represented by step 374, return an ad placement ID identifying such relevant advertisement placement to the ad server 44.

The ad server 44 initiates a Return Ad method call to the listener 22 of the client system 14 at step 376. The Return Ad method call includes the ad placement and, in response thereto, the listener 22 initiates rendering of the ad placement in association with the browser 16. Such rendering may be by way of rendering the ad placement within a frame 280 of the chatbar (FIG. 7).

Further yet, referring again to FIG. 4 in conjunction with FIG. 1, the systems may support functions of hot slings, recent slings, and related slings in response to user activation of the hot sling control 63a, the recent sling control 63b and the related sling control 63c.

In more detail, the client system may initiate a hot/recent/related sling request (HRR request method call) to the lobby service 32 following user activation of such a control. As depicted by box 380, the HRR request method call includes at least the user ID and identifies the request as a combination of one or more of a hot sling request, recent sling request, or related sling request.

In response to the HRR Request method call, the lobby service 32 may pass the request to an HRR system 65 as represented by step 382. The HRR system 65 may reference the slung page data store 40 for purposes of identifying the requesters recent inbound, and outbound slings as represented by step 384, reference a slung page statistics module 390 for purposes of identifying HOT slings (e.g. most common slings within demographically and/or behaviorally similar users) as represented by step 386, and reference a page analysis/categorization module 392 for purposes of identifying pages related to the user's identified page as represented by step 388.

After obtaining applicable data at steps 384, 386, and 388, the HRR system 65 may build a web page that includes the user requested information (e.g. the HOT, recent, or related slings) at step 394.

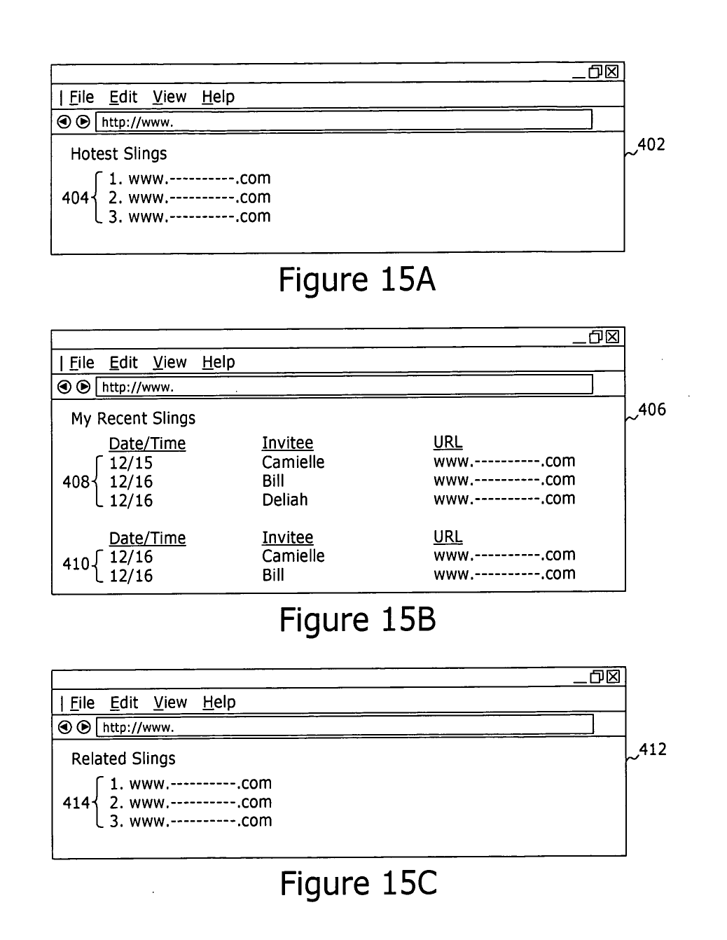

Turning briefly to FIG. 15a, an exemplary web page 402 depicts rendering of identified HOT slings 402. FIG. 15b depicts an exemplary web page 406 depicting the user's most recent outbound slings 408 and inbound slings 410. FIG. 15c depicts and exemplary web page 412 depicting related slings 414.

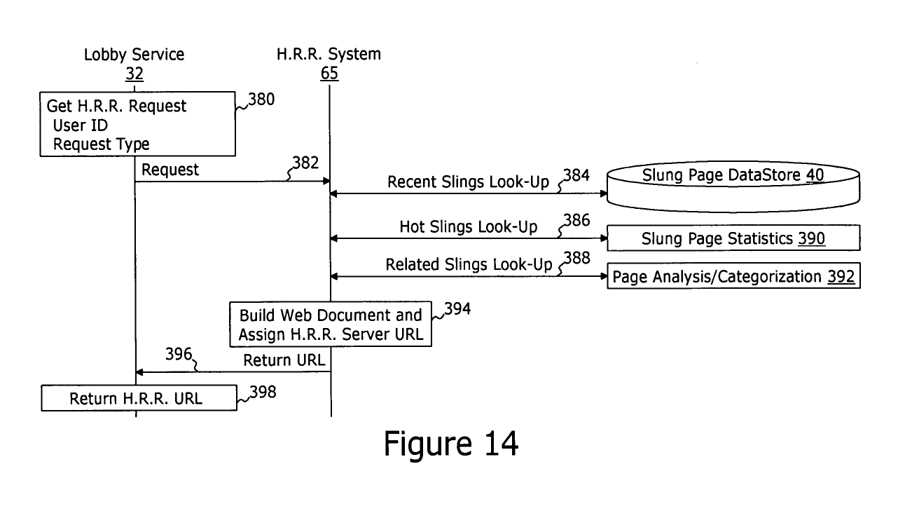

Returning to FIG. 14 in conjunction with FIG. 1, after building the web document, a URL associated with an HRR server 67 (e.g a HRR URL) is assigned to the web document and returned to the lobby service 32 at step 396.

The lobby service 32 is adapted to return the HRR URL to the client at step 398 by initiating an HRR Return method call to the listener 22. In response thereto, the listener 22 may initiate an Overload Page method call to the plug-in 19 for purposes of directing the browser 18 to connect to the HRR URL and obtain the web document.

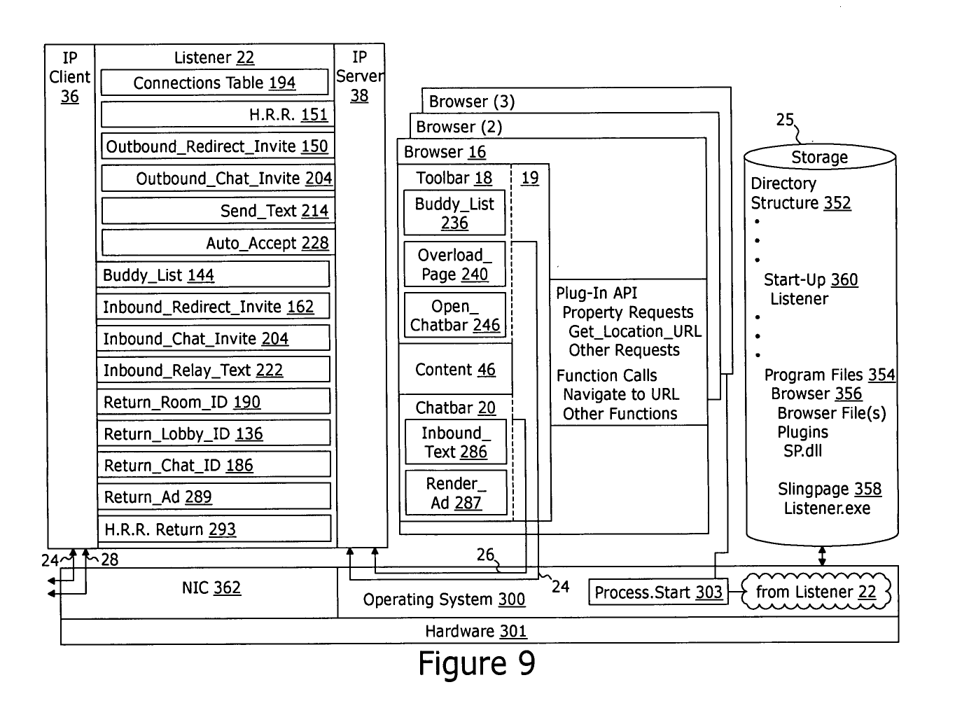

FIG. 9 depicts a more detailed block diagram of a client system 14 configured to facilitate social browsing in accordance with the present invention. The client system 14 may comprise a networked computing device with web browsing functions such as a desk top computer, a note book computer, a mobile telephone, PDA, or other similar device.

In general, the client system 14 includes various hardware systems 301 including network interface circuitry 362 for providing lower level communication services for establishing the TCP/IP connections 24 and 28 with the infrastructure systems 12 over the Internet. The client 14 further includes an operating system 300 local storage (such as a hard drive) 25, the web browser application 16, and the local component represented by the listener 22 and the plug-in component 19—inclusive of the toolbar 18 and the chatbar 20.

In more detail local storage or hard drive 25 stores a plurality of files in a traditional directory structure 352. For purposes of illustrating the present invention, the directory structure 352 may comprises a directory for storage of program files—typically called program files directory 354. Within the program files directory 354 may be a web browser sub directory 356 and a slingpage subdirectory 358.

The web browser sub directory 356 may include one or more web browser files and/or directories comprising one or more web browser files which, when loaded to executable memory spawns an instance of the web browser 16, inclusive of plug in 19 and any other plug-ins identified in the applicable registry.

The slingpage subdirectory comprises one or more listener files which, when loaded to executable memory, spawns the listener 22.

The operating system 300 may be a traditional operating system such as Windows XP available from Microsoft Corporation. Amongst other functions provided by the operating system 300 the operating system 300 includes a function of loading, upon system start up, those applications identified in a Start Up directory 360 of the directory structure 352. For purposes of illustrating the present invention, at least listener 22 may be identified in the start up directory such that listener 22 is loaded upon system start up.

The operating system 300 further provides TCP/IP services enabling TCP/IP client applications to establish TCP/IP connections with TCP/IP server application. More specifically, for purposes of this invention: i) the TCP/IP services and networking hardware 362 enable the browser 16 and a TCP/IP client application 36 of the listener 22 to establish TCP/IP connections with remote TCP/IP server systems such as the Infrastructure systems 12; and ii) the TCP/IP services enable TCP/IP client functions of toolbar 18 and chatbar 20 to establish local TCP/IP connections with a TCP/IP server application 38 of listener 22.

The operating system may provide the Process.Start function 303 which, as discussed, may be a function available to be called by listener 22 for purposes of spawning a new instance of browser 16 and directing such new instance of browser 16 to a specified URL.

Each Browser system 16 inclusive of installed plug-in 19, includes a plug-in API 353 making typical property requests and function calls available to installed plug-ins such as plug-in 19. For purposes of illustrating the present invention: i) the property requests include at least a Get_Location_URL property request which, in response to receipt therefore from the plug-in 19, the browser 16 returns identification of the URL from which the current rendered web content was obtained; and ii) the function calls include at least a Navigate_To_URL function which, in response to receipt thereof from the plug-in 19, the browser connects to a URL identified in the function call and overloads current content with content obtained from the URL.

As discussed with respect to FIG. 1, each plug-in 19 comprises a tool bar 18 and a chatbar 20. Amongst other functions, the plug-in 19 makes at least the following methods available for calling by the locally installed listener 22: i) a Buddy_List method 236; ii) an Overload_Page method 240; iii) an Open_Chatbar method 246, and Inbound_Text method 286; and iv) a Render Ad method 287.

The listener 22 includes an IP server system 38 for establishing and maintaining, for each instance of the browser 16, tool bar TCP/IP connection 24 and the chatbar TCP/IP connection 26.

The listener 22, amongst other function, makes the following methods available for calling by plug-in 19 over such TCP/IP connections 24 and 26: i) an Outbound_Redirect_Invite method 150; ii) an Outbound_Chat_Invite method 204; iii) a Send_Text method 214; iv) an Auto_Accept method 228 and v) an HRR method 151.

Referring to FIG. 9 in conjunction with FIG. 1, the listener 22 includes an IP client system 36 for establishing and maintaining IP connections with the remote infrastructure systems 12 and, in particular, the TCP/IP connection 28 with a lobby service system 32 and TCP/IP connection 29 with a chat service system 34.

The listener 22, amongst other function, makes the following methods available for calling by the remote infrastructure systems 12: i) a Buddy_List method 144 (discussed with respect to FIG. 5); ii) an Inbound_Redirect_Invite method 162; iii) an Inbound_Chat_Invite method 204; iv) an Inbound_Relay_Text method 222; v) a Return_Room_ID method 190; vi) a Return_Lobby_ID method 136; vii) a Return_Chat_ID method 186; viii) a Return_Ad method 289; and ix) an HRR Return method 293.

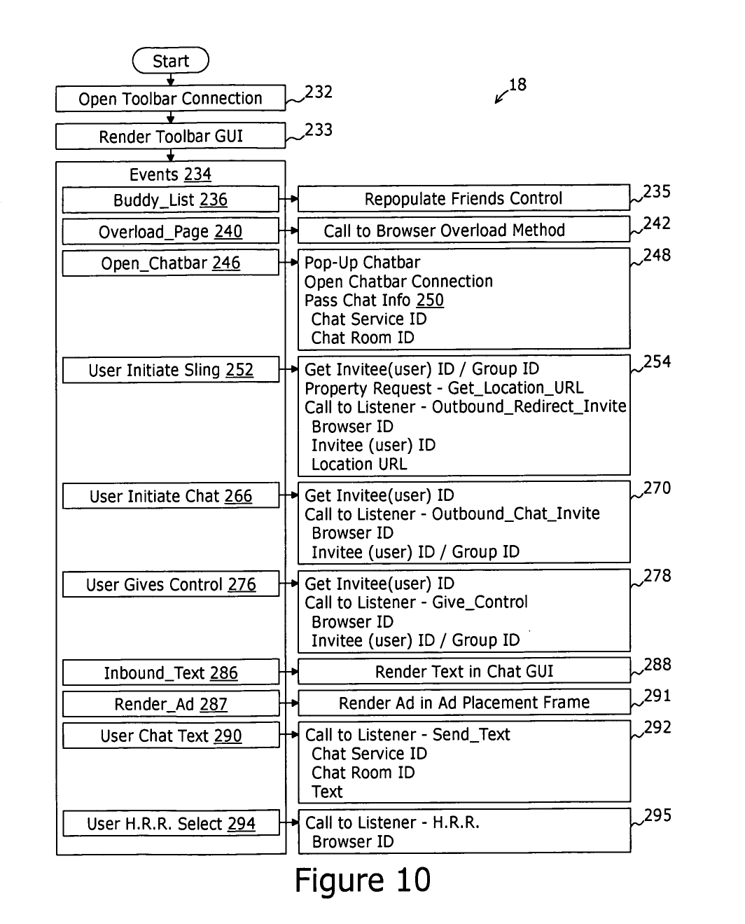

FIG. 10 depicts exemplary operation of the plug-in 19—inclusive of the methods discussed with respect to FIG. 9. Referring to FIG. 10 in conjunction with FIG. 9, upon the operating system 300 spawning a new instance of the browser 16, the plug-in 19 inclusive of the plug-in component 19, opens the toolbar TCP/IP connection 24 to the listener 22 operating on the client system 14 and renders the tool bar GUI 18. These processes are represented by box 232 and box 233 respectively.

Thereafter, the plug-in 19 makes the various methods available for calling by the listener 22. Such methods include the Buddy_List method 236, the Overload_Page method 240, the Open_Chatbar method 246; the Inbound_Text method 286; and the Render_Ad method 287.

Further, the plug-in 19 may perform certain functions (inclusive of initiating certain method calls to the listener 22) in response to user interaction events with the tool bar 18 or the chatbar 20. With respect to the tool bar 18, these user interaction events include: i) the user initiating a sling 252 (e.g. activating the redirect control 50); ii) the user initiating a chat 266 (e.g. activating the sling page control 50 and/or the chat control 52); iii) the user giving control of a web browser window to a buddy 276 (e.g. activating the auto accept control 54; and iv) the user initiating one of a hot slings, recent slings, or related slings request (e.g activating control 63a, 63b, and/or 63c). With respect to the chatbar 20, the user interaction events include the user entering chat text and activating the send control (FIG. 7).

The Buddy_List method 236 includes a process 235 which represents populating, or repopulating, the list of friends (e.g. user ID for each friend) in the buddy control 58 (FIG. 5), and the status of each, in accordance with those buddy's and their status identified in the Buddy List method call provided by the listener 22. This process is represented by box 235.

The Overload_Page method 253 includes a process 242 which represents initiating a call to the web browsers navigate to URL method for purposes of directing the browser to the URL included in the Overload Page method call received from the listener 22.

The Open_Chatbar method 246 includes functions of: i) opening the chatbar 20 within the browser window or otherwise generating the chatbar GUI 20 (FIG. 8) in association with the web browser; and ii) passing chat resource information to the newly rendered chatbar 20 to enable the newly spawned chatbar 20 to send and receive text. The chat resource information may include at least the Chat Service ID and the Chat Room ID. These function are represented by box 248.

The Inbound_Text method 186 includes a function of rendering the text in the chatbar GUI 20 (FIG. 8) The function is represented by box 288.

The Render_Ad method 287 includes a function of rendering the ad within a placement window 280 in association with the browser—which may be a placement window 280 within the chatbar 20 as depicted in FIG. 7.

Functions performed in response to the user initiating a sling 252 (e.g. activating the sling page control 50) include: i) obtaining identification of the Invitee (by user ID) by means of rendering the buddy list GUI 58 (FIG. 5) and obtaining user selection of the selected buddy; ii) generating a Get_Location_URL property request to the plug-in API of the browser 16 for purposes of obtaining the URL from which the web content 46 currently rendered by the browser was obtained. This web content 46 may be referred to as the location URL or the location URL to which the remote browser is intended to be redirected.

After obtaining the Invitee ID and the location URL, the tool bar 18 initiates the Outbound Redirect Invite method call to the listener 22. The Outbound Redirect Invite Method call includes at least the browser ID, the Invitee ID, and the Location URL. These function are represented by box 254.

Functions performed in response to the user initiating chat 266 include: i) obtaining identification of the Invitee (by user ID) by means of rendering the buddy list GUI 58 (FIG. 5) and obtaining user selection of the selected buddy; and ii) initiating the Outbound chat Invite method call to the listener 22. The Outbound Chat Invite method call includes at least the browser ID and the invitee ID. Such functions are resented by box 270.

Functions performed in response to the user giving control of a web browser window to a buddy 276 include: i) obtaining identification of the Invitee (by user ID) to which control is to be given; and ii) initiating the Give Control method call to the listener 22. The Give Control Method call includes at least the browser ID and the Invitee ID. In an situation where the instance of the browser already includes, or is associated with, an open chatbar GUI 20 (FIG. 8), the Invitee ID may be, by default, the ID of the user with which chat session exists. These function are represented by box 278.

Functions performed in response to the user activating one of the hot, recent, or related sling controls 63a, 63b, and/or 63c include generating an HRR method call to the HRR method of the listener 22. The method call includes at least the browser ID and identification of the request type.

The functions performed in response to the user typing chat text into the chatbar GUI 20 includes the Send Text method call to the listener 22. The Send Text method call includes at least the Chat Server ID, Chat Room ID, and the typed text. These function are represented by box 292.

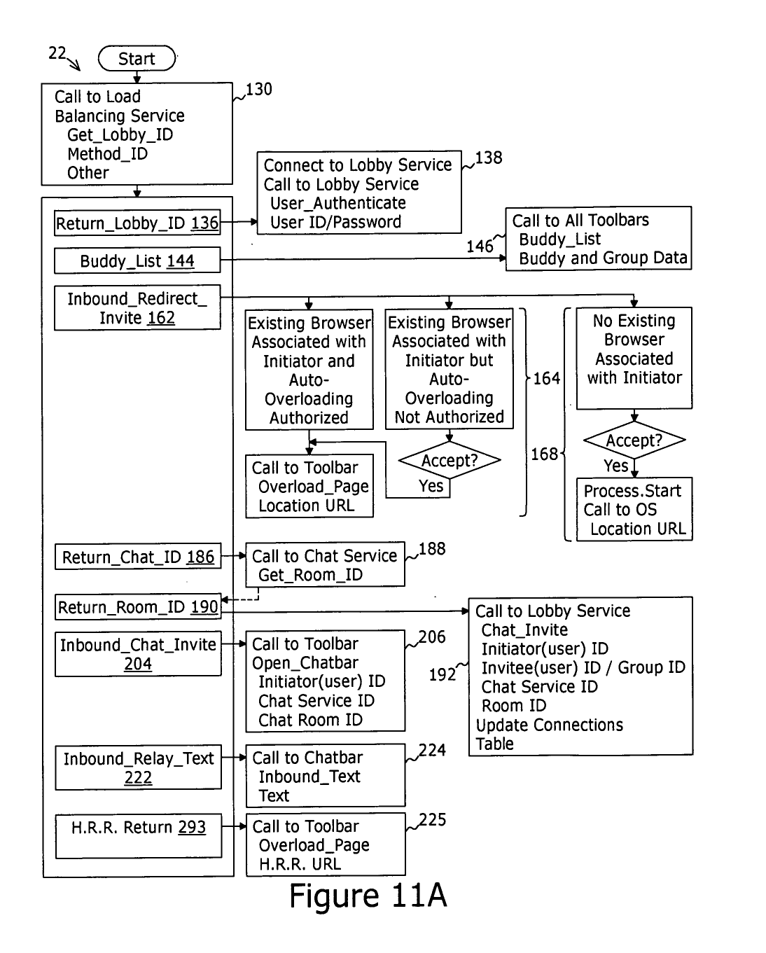

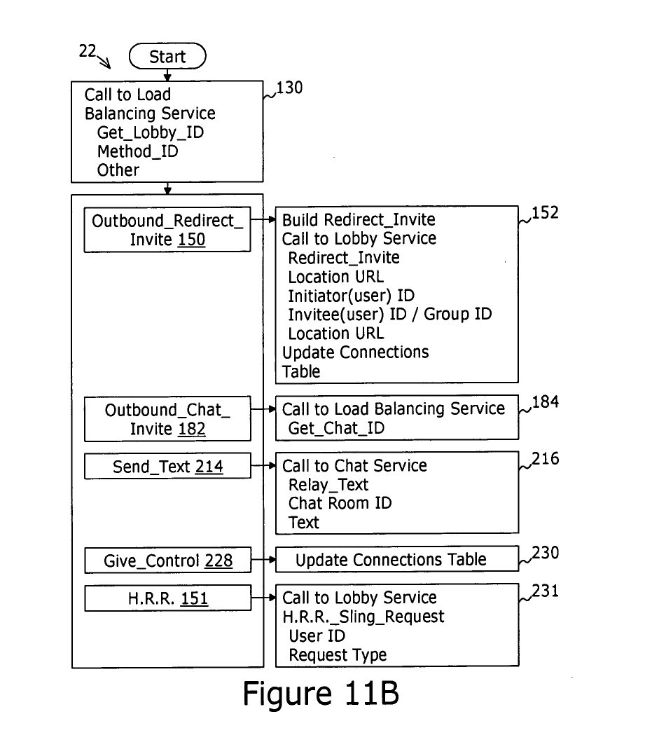

FIGS. 11a and 11b depict exemplary operation of the listener 22—inclusive of the methods discussed with respect to FIG. 9. Referring to FIG. 11a in conjunction with FIG. 1, upon the operating system 300 loading the listener 22 into memory for execution, the listener generates a Get Lobby ID method call to the load balancing service using predetermined load balancing service connection information stored on the client system 14. This method call is represented by step 130.

Thereafter, the listener 22, through the IP client 36, makes various methods available for calling by the remote infrastructure systems 12 with which the listener 22 has established a TCP/IP connection—including the load balancing service 30, lobby service system 32, and chat services system 34. These methods include: i) the Return_Lobby_ID method 136; ii) the Return_Chat_ID method 186; iii) the Return_Room_ID method 190; iv) the Inbound_Redirect_Invite method 162; v) the Inbound_Chat_Invite method 204; vi) the Buddy List method 144; vii) the Inbound_Relay_Text method 222; viii) the Return_Ad method 289; ix) the Give_Control method 228; and x) the HRR Return method 293.

The Return_Lobby_ID method 136, in response to a Return Lobby ID method call from the load balancing server 30 is adapted to: i) establish the TCP/IP connection 24 to the identified lobby services system 32; and ii) initiate the Authenticate_User method call to the lobby service system 32. These functions are represented by box 138.

The Buddy_List method 144, in response to receipt of a Buddy_List method call from the lobby service system 32 is adapted to generate a local Buddy List method call to each toolbar 18 operating on the local system 14.

The Inbound_Redirect_Invite method 162, in response to receipt of an Inbound Redirect Invite method call from the lobby service system 32 is adapted to, if there is no existing browser open that is associated with the initiator (e.g. an existing social browsing session with the initiator as recorded in the connections table 194 depicted in FIG. 12) and render the invite window 96 as depicted in FIG. 6 for purposes of soliciting the user's acceptance of the inbound redirect.

If the user accepts the inbound redirect, the listener 22 calls the applicable method (such as process.start) of the operating system 300 for purposes of spawning a new instance of the browser 16 and directing such new instance of the browser 16 to load the web content available at the predetermined location URL included in the Inbound Redirect method call. These functions are represented by reference numeral 168.

Alternatively if a record in the connections table 194 (FIG. 12) indicates that there is an existing browser 16 associated with the initiator identified in the Inbound Redirect Invite method call, the listener 22 may: i) render the invite window 96 (as depicted in FIG. 6) for purposes of soliciting the user's acceptance of the inbound redirect and, upon user acceptance, initiate the Overload Page method call to the toolbar 18 of such browser; or ii) if the control status 348 of such record in the connections table 194 indicates that the user has activated the auto accept control 54 within such existing browser 16, simply initiate the Overload Page method call to the toolbar 18 of such browser. These functions are represented by reference numeral 164.

The Return_Chat_ID method 186, in response to receipt of a Return Chat ID method call from the load balancing server 30 is adapted to, i) establish the TCP/IP connection 24 to the identified chat services system 34, and ii) initiate the Get Room ID method call to the chat service system 34. These functions are represented by box 188.

The Return_Room_ID method 190, in response to receipt of a Return Room ID method call from the chat service system 34 is adapted to, i) initiate the Chat Invite method call to the lobby services system 32; ii) initiate the Open Chatbar to the instance of the toolbar 18 initiating the chat session; and iii) update the applicable fields of the connections table 194 (FIG. 12). These function are represented by box 192.

The Inbound_Chat_Invite method 204, in response to receipt of an Inbound Chat Invite method call from the lobby service system 32, is adapted to: i) initiate the Open Chatbar method call to the instance of the toolbar 18 associated with the initiator of the chat session (as depicted in the connections table 194); and iii) update the applicable fields of the connections table 194 (FIG. 12). These functions are resented by box 206.

The Inbound_Relay_Text method 222, in response to receipt of an Inbound Relay Text method call from the chat service system 34, is adapted to: i) initiate the Inbound Text method call to the chatbar 20 associated with the chat session in the connections table 194 (FIG. 12). This function is represented by box 224.

The Return_Ad method 289, in response to receipt of a Return Ad method call from the ad server 44, is adapted to render the advertisement placement in conjunction with the instance of the web browser. Such rendering may be by want to initiating a call to the plug in 19 for rendering the ad placement within an ad frame 280 of the chatbar 20.

The HRR Return method 293, in response to receipt of an HRR return method call from the lobby service 32, is adapted to generate an Overload Page method call to the tool bar 18 from which the initial request originated. The Overload Page method call includes identification of the HHR URL such that the toolbar may direct the browser to access the URL for purposes of obtaining the HRR web document.

Returning again to FIG. 9, the listener 22 also, through the IP server 38, makes various methods available for calling by local instances of the plug in 19, inclusive of the toolbar 18 and/or the chatbar 20, that have established local tool bar or chatbar TCP/IP connections to the listener 22. These methods include: i) the Outbound_Redirect Invite method 150; ii) the Outbound_Chat_Invite method 204; iii) the Send_Text method 214; iv) the Auto_Accept method 228; and v) the HRR method 151.

Referring to FIG. 11b in conjunction with FIG. 9, the Outbound_Redirect_Invite method 150, in response to an Outbound Redirect Invite method call from a toolbar 18, is adapted to: i) look up the information required for initiating the Redirect Invite method call to the lobby service system 32; ii) initiate the Redirect Invite method call to the lobby service system 32; and iii) update the connections table 94 (FIG. 12). This function is represented by box 152.

The Outbound_Chat_Invite method 182, in response to an Outbound Chat Invite method call from a toolbar 18, is adapted to: i) initiate the Get Chat ID method call to the load balancing server 30; and iii) update the connections table 94 (FIG. 12). This function is represented by box 184.

The Send_Text method 214, in response to a Send Text method call from a chatbar 20, is adapted to: i) initiate the Relay Text method call to the chat service system 34 as represented by box 216.

The Auto_Accept method 182, in response to a Give Control method call from a toolbar 18, is adapted to update the control status 348 of the browser in the connections table 194 (FIG. 12) as represented by box 230.

The HRR method 151, in response to an HRR method call from a toolbar 18, is adapted to initiate the HHR Sling Request call to the lobby service as represented by box 231.

Although the invention has been shown and described with respect to certain exemplary embodiments, it is obvious that equivalents and modifications will occur to others skilled in the art upon the reading and understanding of the specification. For example, the data relationships represented in various figures are exemplary only. As another example, although an implementation of delivering hot, recent, and related slings to a user includes the systems as discussed utilizing method calls through the listener, alternative embodiments may include a browser directly establishing a URL to the HRR server, posting user data directly to the HRR server, and the HRR server performing the steps discussed with respect to FIG. 14. Those skilled in the art will appreciate that database design for implementation may utilize other data relationships to achieve the objectives of the present invention. The present invention includes all such equivalents and modifications, and is limited only by the scope of the following claims.

What is claimed is:

1. A social browsing system for operation with a source client system operated by a first user and at least one target client system operated by a second user, each of the source client system and the target client system comprising a web browser executing thereon, the social browsing system comprising:
a social browsing infrastructure system; and
a local component for installation on each of the source client system and the target client system, the local component comprising:
a browser plug-in adapted to load with each instance of the browser and being further adapted to establish a toolbar communication connection to the listener module, the plug-in further comprising:
source plug-in functions; and
target plug-in functions; and
a listener module comprising:
a client module adapted to maintain a communication connection with the social browsing infrastructure system;
a server module adapted to maintain, with each instance of the tool bar module, the toolbar communication connection therewith;
source listener functions; and
target listener functions;
the source plug-in functions being adapted to:
render a redirect control in association with the browser;
upon user activation of the redirect control, generate a properties request to the browser to obtain a location URL, the location URL being a URL of a web page being rendered by the instance of the browser at the time of the properties request;
receive identification of the location URL in response to the properties request;
obtain an identification associated with the second user;
generate an outbound redirect invite method call to the listener module utilizing the tool bar communication connection, the outbound redirect invite method call comprising identification of the location URL and the identification associated with the second user; and
the source listener functions being adapted to, in response to receiving the outbound redirect invite method call, generate a redirect invite method call to the remote social browsing infrastructure system, the redirect invite method call comprising at least the identification of the location URL and the identification associated with the second user;
the target listener functions comprise an inbound redirect invite method responsive to an inbound redirect method call initiated by the social browsing infrastructure system, the inbound redirect method being adapted to generate an overload page method call to the plug-in, the overload page method call comprising at least a URL received in the inbound redirect method call from the remote social browsing infrastructure system; and
the target plug-in functions comprising an overload page method responsive to receipt of the overload page method call from the listener module, the overload page method being adapted to direct the instance of the browser to load a web document obtained from a web server associated with the URL into an existing browser window; and
the social browsing infrastructure systems being adapted to, in response to receiving the redirect invite method call, generate the inbound redirect invite method call to the target client system.

2. The system of claim 1, wherein the source plug-in function of obtaining an identification associated with the second user includes:
rendering a buddy list control in association with the browser, the buddy list control displaying a list of at least two identifications; and
obtaining the identification associated with the second user by first user
identification of a selected one of the at least two identifications.

3. The system of claim 1, wherein the inbound redirect invite method is further adapted to:
in response to receipt of the inbound redirect invite method call, render an acceptance control; and
generate the overload page method call only in response to user activation of the acceptance control.

4. the system of claim 3, wherein the inbound redirect invite method is further adapted to:
only generate the overload page method call to an instance of the browser that is associated with an initiator ID matching identification of an initiator included in the inbound redirect invite method call; and
if the identification of an initiator included in the inbound redirect invite method call does not match an initiator ID associated with an existing instance of the browser: i) generate a processing call to launch a new instance of the browser upon user activation of the acceptance control; and ii) associate the new instance of the browser with the identification of the initiator included in the inbound redirect invite method call.

5. The system of claim 1, wherein:
the source listener functions are further adapted to:
generate a get room ID method call to the social browsing infrastructure systems and receive, in response thereto, identification of a chat room; and
generate a chat invite method call to the social browsing infrastructure system;
the plug-in is further adapted to:
render a chatbar graphical user interface in association with the browser; and
upon user entry of text into the chatbar, generating a relay text method call to the listener; and
the source listener functions are further adapted to, in response to the relay text method call, generate a relay text method call to the remote social browsing infrastructure system, the relay text method call including both the text and the chat room ID.

6. The system of claim 5, wherein:
the target listener functions are further adapted to:
in response to receipt of an inbound chat invite method call from the remote infrastructure system, the inbound chat invite method call identifying a chat resource;
associate the chat resource with an instance of the browser;
generate an open chat method call to the plug-in of the instance of the browser, the open chat method call identifying the chat resource; and
the plug-in is adapted to render the chatbar graphical user interface in association with the browser in response to receipt of the open chat method call.

7. The system of claim 1, wherein the listener module further comprises a get advertisement function, the get advertising function being adapted to:
generate an ad request for transfer to an advertisement system; and
receiving, in response to the ad request, an advertisement placement for rendering in association with the local browser; and
wherein the advertisement request includes at least one of: i) identification of the location URL, and ii) identification of a portion of content of the web page being rendered by the local browser.

8. A local system for operation with at least one instance of a web browser of a source client system operated by a first user, with a remote social browsing infrastructure system, and at least one target client system operated by a second user for purposes of redirecting a browser operating on the target client system to a location URL, the local system comprising:
a listener module comprising:
a client module adapted to maintain a communication connection with the remote social browsing infrastructure system; and
a server module adapted to maintain, with each of a plurality of instances of a browser plug-in, a tool bar communication connection therewith;
each instance of the browser plug-in operating in conjunction with an instance of browser and being adapted to:
establish the toolbar communication connection to the listener module;
render a redirect control in association with the instance of the browser; and
upon user activation of the redirect control, generate a properties request to the instance of the browser to a location URL, the location URL being a URL of a web page being rendered by the instance of the browser at the time of the properties request;
receive identification of the location URL from the instance of the local browser in response to the properties request;
obtain an identification associated with the second user; and
generate an outbound redirect invite method call to the listener module utilizing the toolbar communication connection therewith, the outbound redirect invite method call comprising identification of the location URL and the identification associated with the second user; and
the listener module comprising an outbound redirect invite method responsive to the outbound redirect invite method call and being adapted to generate a redirect invite method call to the remote social browsing infrastructure systems over the communication connection therewith, the redirect invite method call comprising at least the identification of the location URL and the identification associated with the second user.

9. The local system of claim 8, wherein the plug-in is further adapted to:
render a buddy list control in association with the browser, the buddy list control displaying a list of at least two identifications; and
obtain the identification associated with the second user by first user selection of one of the at least two identifications.

10. The local system of claim 8, wherein:
the listener module further comprises an inbound redirect invite method callable by the remote social browsing infrastructure system, the inbound redirect invite method being adapted to:
if an instance of the browser is associated with an initiator identified in the inbound redirect invite method call, generate an overload page method call to the plug-in of the instance of the browser associated with the initiator, the overload page method call comprising at least a URL received in the inbound redirect invite method call from the remote social browsing infrastructure system; and
if the initiator identified in the inbound redirect invite method call is not associated with an existing instance of the browser: i) generate a processing call to launch a new instance of the browser; and ii) associate the new instance of the browser with the initiator identified in the inbound redirect invite method call;
the plug-in further comprising an overload page method responsive to receipt of the overload page method call from the listener module, the local overload page method being adapted to direct the instance of the browser to load a web document obtained from a web server associated with the URL into an existing browser window:

11. The local system of claim 10, wherein the listener module is further adapted to:
in response to receipt of the inbound redirect invite method call, render an acceptance control; and
generate the overload page method call to the plug-in only in response to user activation of the acceptance control; and
generate the processing call to launch a new instance of the browser only in response to user activation of the acceptance control.

12. The local system of claim 8, wherein:
the listener module is further adapted to:
generate a get room ID method call to the social browsing infrastructure system and receive, in response thereto, identification of a chat room; and
generate a chat invite method call to the social browsing infrastructure system;
the plug-in is further adapted to:
render a chatbar graphical user interface in association with the browser; and
upon user entry of text into the chatbar, generate a relay text method call to the listener; and
the listener module is further adapted to, in response to the relay text method call, generate a relay text method call to the remote social browsing infrastructure system, the relay text method call including both the text and the chat room ID.

13. The local system of claim 12, wherein:
the listener module is further adapted to, in response to receipt of an inbound chat invite method call from the remote infrastructure system, the inbound chat invite method call identifying a chat resource:
associate the chat resource with an instance of the browser;
generate an open chat method call to the plug-in of the instance of the browser, the open chat method call identifying the chat resource; and
the plug-in is adapted to render the chatbar graphical user interface in association with the browser in response to receipt of the open chat method call.

14. The local system of claim 8, wherein the listener module further comprises a get advertisement function, the get advertising function being adapted to:
generate an ad request for transfer to an advertisement system; and
receiving, in response to the ad request, an advertisement placement for rendering in association with the local browser; and
wherein the advertisement request includes at least one of: i) identification of the location URL, and ii) identification of a portion of content of the web page being rendered by the local browser.

15. A plug-in to a local browser operated by a first user for redirecting a remote browser operating on at least one target client system operated by a second user to a location URL, the plug-in comprising:
a tool bar graphical user interface adapted to render a redirect control in association with an instance of the browser;
an invite function operating in response to user activation of the redirect control, the invite function being adapted to:
generate a properties request to the browser to obtain a location URL, the location URL being a URL of a web page being rendered by the browser at the time of the properties request;
receive identification of the location URL in response to the properties request;
obtain an identification associated with the second user; and
initiate transfer of the location URL to the second user.

16. The plug-in of claim 15, wherein the tool bar graphical user interface is further configured to:
render a buddy list control displaying a list of at least two identifications; and
obtain the identification associated with the second user by first user identification of a selected one of the at least two identifications.

17. The plug-in of claim 15, further comprising:
an overload page method adapted to, in response to a receipt of an overload page method call identifying a remote URL, initiate a process call to an application interface of the browser to direct the browser to connect to the remote URL and obtain a web document for loading into an existing browser window.

18. The plug-in of claim 15, further comprising:
a chat invite function operating in response to user activation of one of the redirect control and a chat control of the tool bar graphical user interface, the chat invite function being adapted to:
initiate establishing a chat session with the target client system;
render a chatbar graphical user interface in association with the browser; and
upon user entry of text into the chatbar graphical user interface, initiate relay of the text to the target client system.

19. A social browsing system for operation with a source client system operated by a first user and at least one target client system operated by a second user, each of the source client system and each target client system comprising a web browser executing thereon, the social browsing system comprising:
a social browsing infrastructure system; and
a local component for installation on each of the source client system and the target client system, the local component comprising source functions and target functions;
the source functions being adapted to:
render a redirect control in association with an instance of the web browser;
in response to user activation of the redirect control, obtain a location URL from the web browser, the location being a URL of web content being rendered by the instance of the browser; and
generate a redirect invite to the social browsing infrastructure system, the redirect invite comprising at least identification of the location URL and an identification of second user;
the social browsing infrastructure system being adapted to, in response to receiving the redirect invite:
identify the target client system operated by the second user;
generate an inbound redirect invite to the target client system; and
identify an advertisement placement related to at least one of: i) web content at the location URL; and ii) behavioral data related to the second user; and
provide the advertisement placement to the target client system;
the target functions being adapted to, in response to receipt of the inbound redirect invite;
initiate a connection to the location URL for rendering of the web content; and
render the advertisement placement in association with the web content.

20. The social browsing system of claim 19, wherein the source functions are further adapted to:
render a buddy list control in association with the browser, the buddy list control displaying a list of at least two identifications; and
obtain the identification associated with the second user by first user identification of a selected one of the at least two identifications.

21. The social browsing system of claim 19, wherein the target functions are further adapted to:
in response to receipt of the inbound redirect invite, render an acceptance control; and
in response to user activation of the acceptance control, initiate a connection to the location URL for rendering of the web content by way of: i) initiating the spawning of a new instance of the browser; and ii) directing an existing instance of the browser to the location URL.

22. The social browsing system of claim 21 further comprising a browser plug-in, and, wherein:
directing an existing instance of the browser to the location URL comprises providing an overload page method call to the plug-in of the existing instance of the browser; and
the plug-in is adapted to overload existing web content by initiating a navigate to location processing call to the browser, the navigate to location processing call including the location URL.

23. The social browsing system of claim 19, wherein:
the source functions are further adapted to:
render a chatbar graphical user interface in association with at least one instance of the browser; and
generate a chat invite to the social browsing infrastructure system, the chat invite including identification of the second user;
the social browsing infrastructure system is further adapted to, in response to receipt of the chat invite, generate in inbound chat invite to the target client system;
the target functions are further adapted to, in response to receipt of the inbound chat invite, render a chatbar graphical user interface in association with an instance of the browser in which web content obtained from the location URL is rendered; and
each chatbar, upon user entry of text into the chatbar, generates a relay text method call to the social browsing infrastructure system for subsequent relay to the other chatbar.
